(19) United States
(12) Patent Application Publication
(10) Pub. No.: US 2024/0415317 A1
(43) Pub. Date: Dec. 19, 2024

(54) BEVERAGE SUPPLY APPARATUS

(71) Applicant: FUJI ELECTRIC CO., LTD., Kawasaki-shi (JP)

(72) Inventor: Shuichi ITO, Yokkaichi-city (JP)

(21) Appl. No.: 18/818,591

(22) Filed: Aug. 29, 2024

Related U.S. Application Data
(63) Continuation of application No. PCT/JP2023/010748, filed on Mar. 17, 2023.

(30) Foreign Application Priority Data
Mar. 17, 2022 (JP) 2022-042601
Mar. 17, 2022 (JP) 2022-042602

(51) Int. Cl. A47J 31/36; A47J 31/06

(52) U.S. Cl. CPC A47J 31/36; A47J 31/0657

(57) ABSTRACT

A beverage supply apparatus includes an extractor that feeds ground coffee beans and hot water into a cylinder to extract coffee. The apparatus supplies the coffee extracted by the extractor to a cup. The extractor includes a passage constituting member having a tubular shape and disposed in such a manner as to allow its interior to communicate with an upper surface opening of the cylinder to constitute a passage of the ground coffee beans and the hot water. The passage constituting member is elastically deformed by an external force to be able to close the passage.

### CROSS-REFERENCE TO RELATED APPLICATION(S)

The present application claims priority to and incorporates by reference the entire contents of the International Patent Application No. PCT/JP2023/010748 filed in Japan on Mar. 17, 2023.

### BACKGROUND

The present disclosure relates to a beverage supply apparatus.

In the related art, there is a known beverage supply apparatus that supplies a beverage to a container such as a cup, having a configuration as below. That is, the apparatus uses an extractor disposed in an apparatus body to extract a beverage from a ground ingredient and hot water and then supplies the extracted beverage to the container such as a cup.

Such an extractor includes a cylinder and a filter block, in which the filter block is brought into proximity to the cylinder in a state where a paper filter is passed between the cylinder and the filter block, the ground ingredient and hot water are fed to the cylinder, and the ground ingredient and hot water are stirred to extract a beverage from the filter block (refer to Japanese Laid-open Patent publication No. 2020-47196, for example).

### SUMMARY

There is a need for providing a beverage supply apparatus capable of suppressing scattering of ingredients and the like from a cylinder.

According to an embodiment, a beverage supply apparatus includes an extractor that feeds a ground ingredient and hot water into a cylinder to extract a beverage, the apparatus configured to supply the beverage extracted by the extractor to a container. Further, the extractor includes a passage constituting member having a tubular shape and disposed in such a manner as to allow its interior to communicate with an upper surface opening of the cylinder to constitute a passage of the ingredient and the hot water, the passage constituting member configured to be elastically deformed by an external force to be able to close the passage.

### BRIEF DESCRIPTION OF DRAWINGS

FIG. 1 is a perspective view illustrating an external configuration of a beverage supply apparatus according to an embodiment of the present disclosure;

FIG. 2 is a schematic diagram schematically illustrating main components of the beverage supply apparatus according to the embodiment of the present disclosure;

FIG. 3 is a perspective view illustrating an external configuration of an extractor illustrated in FIG. 2;

FIG. 4 is a perspective view illustrating an external configuration of the extractor illustrated in FIG. 2;

FIG. 5 is an exploded perspective view of main parts of the extractor illustrated in FIGS. 3 and 4;

FIG. 6 is an explanatory view illustrating an attachment state of a cylinder illustrated in FIG. 5;

FIG. 7 is a perspective view illustrating main parts of the extractor illustrated in FIGS. 2 and 3;

FIG. 8 is a longitudinal sectional view of main parts of the extractor illustrated in FIG. 7;

FIG. 9 is a perspective view of a filter block illustrated in FIGS. 2 and 3;

FIG. 10 is an explanatory view illustrating an internal structure of main parts of the extractor illustrated in FIGS. 3 and 4;

FIG. 11 is a perspective view illustrating main parts of the extractor illustrated in FIGS. 2 and 3;

FIG. 12 is a perspective view illustrating a state in which a pinch mechanism illustrated in FIG. 11 is activated;

Part (a) of FIG. 13 and part (b) of FIG. 13 are longitudinal sectional views of a passage constituting member;

FIG. 14 is an exploded perspective view of main parts of the extractor illustrated in FIGS. 3 and 4;

FIG. 15 is a perspective view illustrating a valve group illustrated in FIG. 2;

FIG. 16 is a perspective view 16 illustrating an external configuration of an air switching valve illustrated in FIG. 15;

FIG. 17 is a longitudinal sectional view illustrating an internal structure of the air switching valve illustrated in FIG. 15;

FIG. 18 is a longitudinal sectional view illustrating an internal structure of the air switching valve illustrated in FIG. 15;

FIG. 19 is a bottom view illustrating an ingredient chute section and a mixing hot water nozzle;

FIG. 20 is an exploded perspective view illustrating a configuration of a coffee valve illustrated in FIG. 15;

FIG. 21 is a perspective view illustrating an external configuration of a joint section illustrated in FIG. 2;

FIG. 22 is a longitudinal sectional view illustrating an internal structure of the joint section illustrated in FIG. 2;

FIG. 23 is an explanatory view illustrating an external configuration of a cleaning liquid pump illustrated in FIG. 2;

FIG. 24 is an explanatory view illustrating an external configuration of the cleaning liquid pump illustrated in FIG. 2;

FIG. 25 is a longitudinal sectional view illustrating an internal structure of the joint section illustrated in FIG. 2;

FIG. 26 is a longitudinal sectional view illustrating the internal structure of the joint section illustrated in FIG. 2;

FIG. 27 is a longitudinal sectional view illustrating the internal structure of the joint section illustrated in FIG. 2;

FIG. 28 is an explanatory view schematically illustrating a beverage extraction procedure by the extractor illustrated in FIG. 2;

FIG. 29 is an explanatory view schematically illustrating a beverage extraction procedure by the extractor illustrated in FIG. 2;

FIG. 30 is an explanatory view schematically illustrating a beverage extraction procedure by the extractor illustrated in FIG. 2; and

FIG. 31 is an explanatory view schematically illustrating a beverage extraction procedure by the extractor illustrated in FIG. 2.

FIG. 32 is an explanatory view schematically illustrating a beverage extraction procedure by the extractor illustrated in FIG. 2.

FIG. 33 is an explanatory view schematically illustrating a beverage extraction procedure by the extractor illustrated in FIG. 2.

FIG. 34 is an explanatory view schematically illustrating a beverage extraction procedure by the extractor illustrated in FIG. 2.

FIG. 35 is an explanatory view schematically illustrating a beverage extraction procedure by the extractor illustrated in FIG. 2.

FIG. 36 is a front view illustrating a modification of the extractor illustrated in FIGS. 3 and 4.

FIG. 37 is a perspective view illustrating a modification of a passage constituting member and a pinch mechanism illustrated in FIG. 11.

### DETAILED DESCRIPTION

In the related art, in the beverage supply apparatus proposed in Japanese Laid-open Patent publication No. 2020-47196, when ingredients and hot water are fed into the cylinder, an upper surface opening of the cylinder is open, having a possibility that the ingredients and the like are scattered as fine powder.

Hereinafter, a preferred embodiment of a beverage supply apparatus according to the present disclosure will be described in detail with reference to the accompanying drawings. 30

### Schematic Configuration of Beverage Supply Apparatus

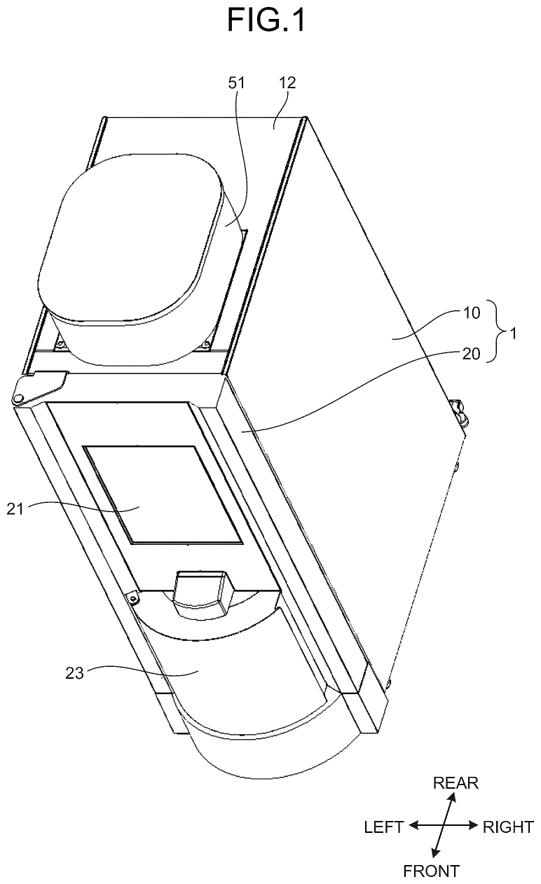

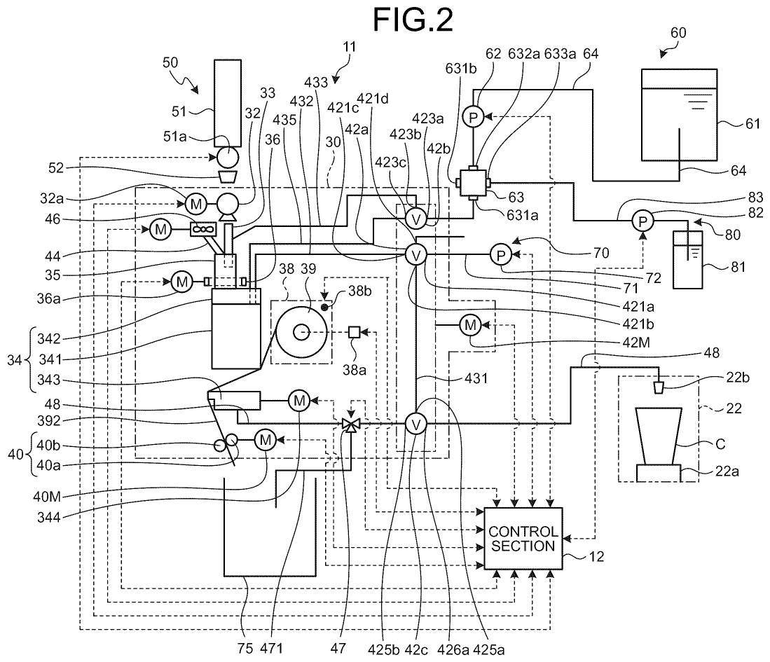

FIGS. 1 and 2 each illustrate a beverage supply apparatus according to an embodiment of the present disclosure. Specifically, FIG. 1 is a perspective view illustrating an external configuration of the beverage supply apparatus, and FIG. 2 is a schematic diagram schematically illustrating main components of the beverage supply apparatus.

The beverage supply apparatus exemplified here is a coffee machine installed in a store such as a convenience store, for example, and configured to perform bean grinding or extraction processing and supply a beverage such as coffee to a cup C, which is a container, for example. The beverage supply apparatus characterized like this includes an apparatus body 1.

The apparatus body 1 includes a main body cabinet 10 and a front door 20. The main body cabinet 10 has a substantially rectangular parallelepiped shape having an opening (not illustrated; hereinafter, also referred to as a front opening) on a front surface, and internally includes: a generation unit 11 that generate a beverage (for example, coffee); and a control section 12.

The front door 20 is a door member having a size sufficient to close the front opening of the main body cabinet 10. The front door 20 is provided at a left edge on a front side of the main body cabinet 10 so as to be swingable about a central axis of a shaft portion (not illustrated) extending in an up-down direction, and can open and close the front opening of the main body cabinet 10. The front door 20 characterized like this has a front surface constituting a service surface, and is provided with a display section 21, a beverage supply section 22, and an opening/closing door 23.

The display section 21 includes, for example, a liquid crystal touch panel, and can display various types of information in accordance with a command given from the control section 12 and can receive an input operation such as a touch operation. The display section 21 sends out a selling signal to the control section 12 in response to the input operation such as a touch operation.

The beverage supply section 22 is located below the display section 21 and has a stage 22a. The stage 22a is a member on which the cup C is to be placed, and has an arc-shaped stopper (not illustrated). There is provided a nozzle 22b detachably attached to the beverage supply section 22. The nozzle 22b is attachable to and detachable from a nozzle attachment portion (not illustrated) provided on the front door 20. The nozzle 22b is attached to the nozzle attachment portion in such a manner as to face the beverage supply section 22. That is, the nozzle 22b is detachably disposed in such a manner as to face the beverage supply section 22.

The opening/closing door 23 is formed of a translucent material such as a transparent resin, for example, and has a size sufficient to cover the beverage supply section 22. The opening/closing door 23 has its left end pivotally supported by the front door 20, and thus is swingable in a front-rear direction. That is, the opening/closing door 23 can swing in the front-rear direction in such a manner as to approach and separate from the beverage supply section 22, and can close the beverage supply section 22 when swinging backward in such a manner as to approach the beverage supply section 22, and can open the beverage supply section 22 when swinging forward in such a manner as to separate from the beverage supply section 22.

The generation unit 11 includes an ingredient supply section 50, a hot water supply section 60, an air supply section 70, and a storage bucket 75, together with an extractor (beverage generation section) 30 which is a beverage extraction apparatus.

The extractor 30 extracts coffee, which is a beverage, from the ingredient supplied from the ingredient supply section 50 and the hot water supplied from the hot water supply section 60, and supplies the extracted coffee to the beverage supply section 22.

The ingredient supply section 50 supplies coffee beans as a beverage ingredient to the extractor 30, and includes an ingredient box 51. The ingredient box 51 stores roasted coffee beans, and is provided in such a manner as to partially protrude upward from a top plate of the main body cabinet 10. The ingredient box 51 is provided with an ingredient supply drive section 51a. The ingredient supply drive section 51a is driven when a drive command is given from the control section 12, and is configured to dispense a predetermined amount of coffee beans specified in the drive command through an ingredient supply chute 52.

The hot water supply section 60 supplies hot water to the extractor 30, and is constituted by sequentially connecting a hot water tank 61, a hot water supply pump 62, and a joint section 63 to a hot water supply path 64 formed with a hot water supply pipe.

The hot water tank 61 heats the supplied water such as tap water by a heater (not illustrated) and stores the heated water as hot water. The hot water supply pump 62 is driven in accordance with a command given from the control section 12, and delivers, when driven, hot water from the hot water tank 61.

The joint section 63 is located on the downstream side of the hot water supply pump 62 in the hot water supply path 64. The joint section 63 is connected to a cleaning liquid supply section 80.

The cleaning liquid supply section 80 supplies a cleaning liquid to the extractor 30, and is constituted by sequentially connecting a cleaning liquid tank 81 and a cleaning liquid pump 82 to a cleaning liquid supply path 83 formed with a cleaning liquid pipe.

The cleaning liquid tank 81 stores a cleaning liquid. The cleaning liquid pump 82 is driven in accordance with a command given from the control section 12, and delivers, when driven, the cleaning liquid from the cleaning liquid tank 81.

The air supply section 70 supplies pressurized air to the extractor 30. The air supply section 70 is constituted with an air pump 72 provided in an air supply path 71 formed with an air supply pipe. The air pump 72 is driven in accordance with a command given from the control section 12, and compresses air and delivered the compressed air as pressurized air.

The storage bucket 75 is installed in a lower region of the extractor 30, and stores extraction residue and the like generated by extraction of the beverage by the extractor 30.

The control section 12 integrally controls operation of each section of the beverage supply apparatus according to a program or data stored in a storage section (not illustrated). Note that the control section 12 may be implemented by causing a processing apparatus such as a central processing unit (CPU) to execute a program, that is, may be implemented by software, may be implemented by hardware such as an integrated circuit (IC), or may be implemented by using software and hardware in combination.

### Extractor 30

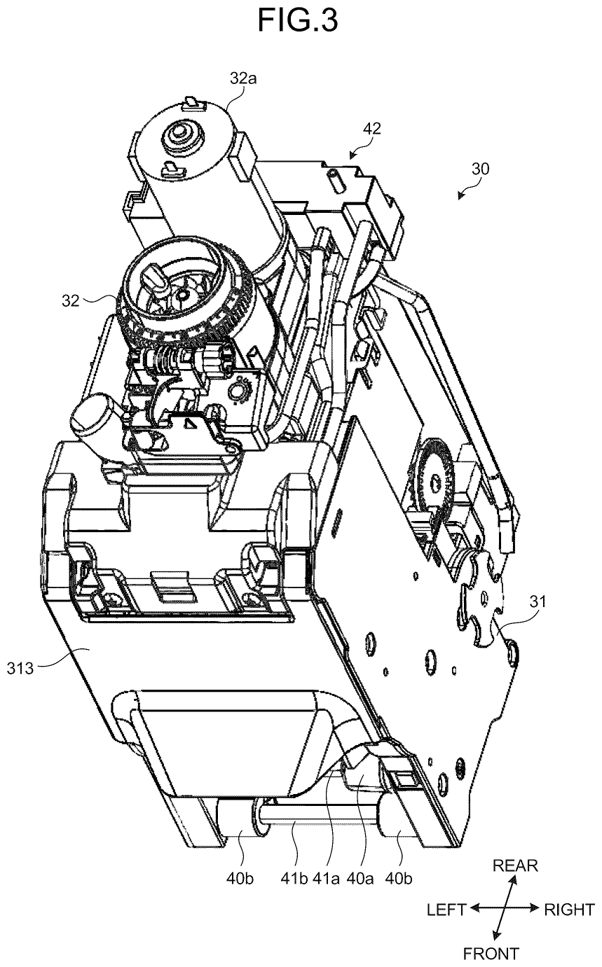

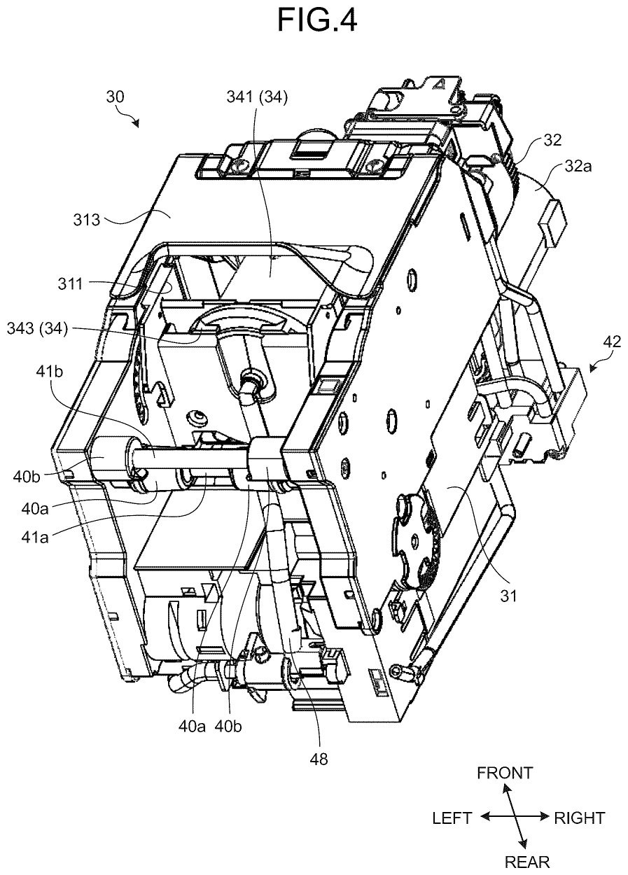

FIGS. 3 and 4 are perspective views each illustrating an external configuration of the extractor 30 illustrated in FIG. 2. As illustrated in FIGS. 3 and 4, the extractor 30 includes an extractor main body 31, and has a configuration in which the extractor main body 31 is provided with a grinder 32, a brewer unit 34, a pinch mechanism 36, a filter storage portion 38, a paper roller portion 40, and a valve group 42.

The grinder 32 is also referred to as a mill, and is provided on an upper portion of the extractor main body 31. The grinder 32 is driven when a drive command is given to a grinder drive section 32a which is an actuator. The grinder 32 is installed in a lower region of the ingredient box 51, and is joined to the ingredient box 51 via the ingredient supply chute 52.

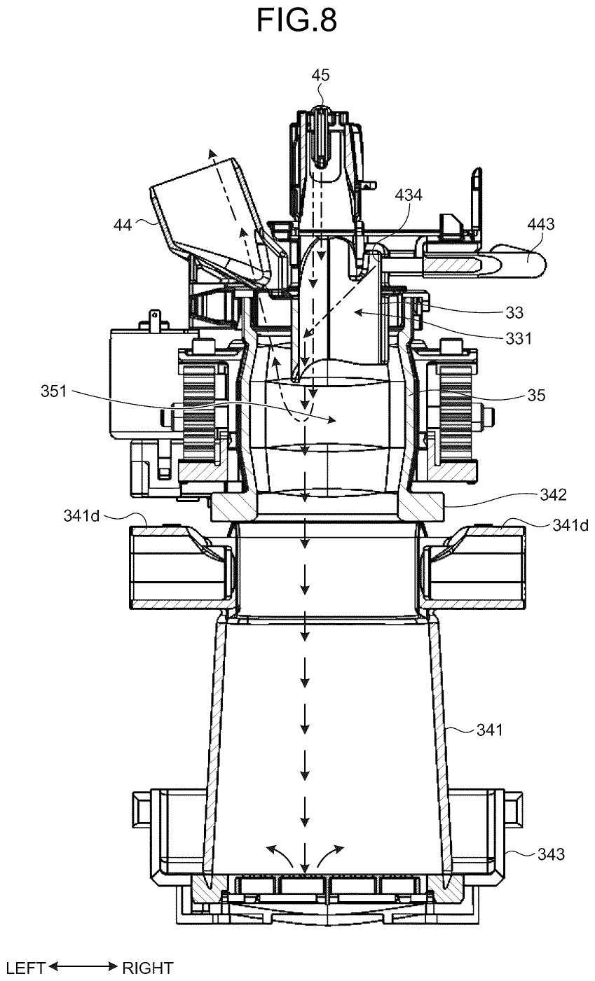

When driven, the grinder 32 grinds the coffee beans guided by the ingredient supply chute 52, and feeds the coffee beans that have been ground (hereinafter, also referred to as ground coffee beans) through an ingredient chute section 33 to the brewer unit 34. The ingredient chute section 33 has an ingredient passage 331 (refer to FIG. 8) for dropping ground coffee beans. The ingredient chute section 33 will be described below.

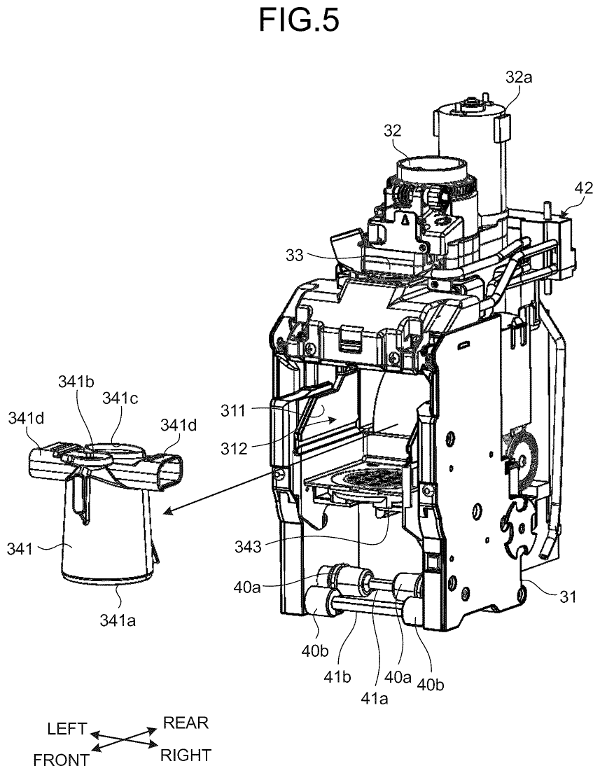

The brewer unit 34 includes a cylinder 341, a lid member 342, and a filter block 343. As illustrated in FIG. 5, the cylinder 341 is detachably attached through a take-out opening 311 on the front surface of the extractor main body 31, and has a substantially tubular shape. The cylinder 341 is detachable from the extractor main body 31, and thus has no clear definition of directions. However, in the present description, the configuration of the cylinder 341 will be described according to the direction when being attached to the extractor main body 31.

The cylinder 341 has one opening (hereinafter, also referred to as a lower surface opening) 341a on the lower surface and two openings on the upper surface (hereinafter, the front side opening is also referred to as a first upper surface opening 341b, and the rear side opening is also referred to as a second upper surface opening 341c). The cylinder 341 has, on its upper portion, ribs 341d protruding outward and provided in a left-right pair, and has, its lower portion, two guide pieces 341e protruding rearward.

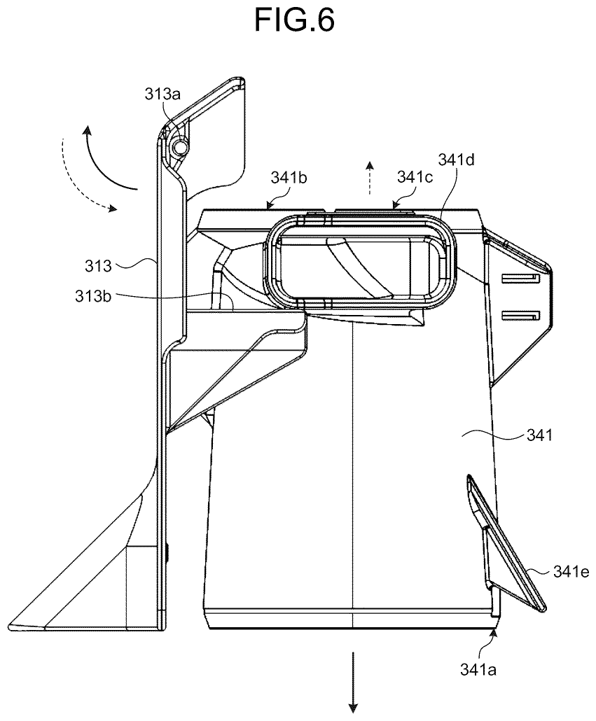

The cylinder 341 characterized like this is attached to an attachment region 312 facing the take-out opening 311 in the extractor main body 31. When attached to the extractor main body 31, the cylinder 341 is pressed upward by a take-out door 313 that opens and closes the take-out opening 311 as illustrated in FIG. 6.

More specifically, the take-out door 313 has, its upper end, a shaft-shaped portion 313a extending in the left-right direction. The shaft-shaped portion 313a is pivotally supported by left and right side edges of the take-out opening 311, so as to allow the take-out door 313 to swing in the front-rear direction about the axis of the shaft-shaped portion 313a. That is, the take-out door 313 closes a part of the take-out opening 311 when swinging forward, and opens the take-out opening 311 when swinging rearward. The take-out door 313 characterized like this has, its rear surface, pressing projections 313b protruding rearward formed in a left-right pair.

When the take-out door 313 characterized like this closes a part of the take-out opening 311, the pressing projection 313b presses the corresponding rib 341d upward as indicated by a broken arrow in FIG. 6, thereby pressing the cylinder 341 upward. On the other hand, when the take-out door 313 swings forward as indicated by a solid arrow in FIG. 6, the pressing projection 313b is separated from the rib 341d, allowing the cylinder 341 to be displaced downward. That is, the movement of the take-out door 313 to swing forward will free the cylinder 341 to be removable from the attachment region 312.

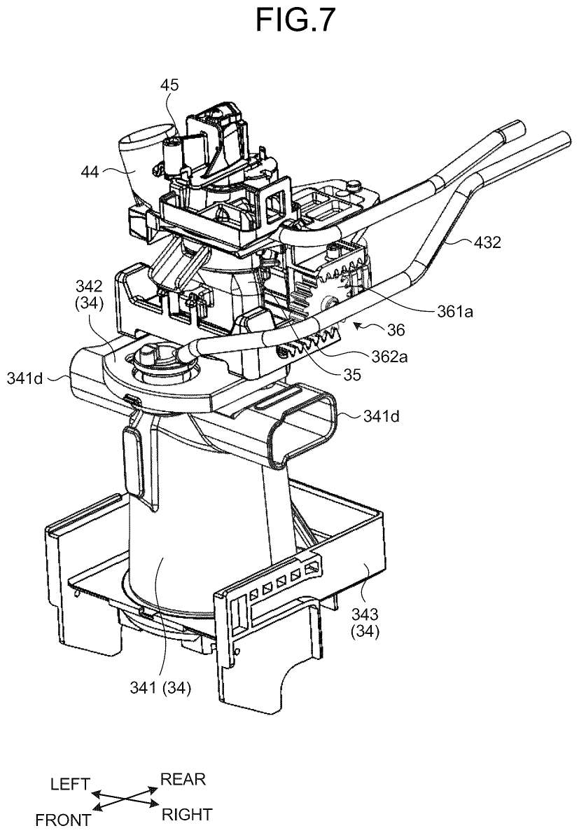

FIG. 7 is a perspective view illustrating main parts of the extractor 30 illustrated in FIGS. 2 and 3. As illustrated in FIG. 7, the lid member 342 is provided on the extractor main body 31 in a manner as to constitute an upper portion of the attachment region 312. The lid member 342 is pressed against the cylinder 341 when the cylinder 341 is pressed upward by the take-out door 313, and covers the upper surface opening (the first upper surface opening 341b and the second upper surface opening 341c) of the cylinder 341.

As also illustrated in FIG. 8, the lid member 342 characterized like this has a passage constituting member 35 having a tubular shape and having its interior communicating with the second upper surface opening 341c, formed in such a manner as to extend upward. The passage constituting member 35 is formed of a resin material such as silicone, for example, and has an elliptical cross section. A part of the ingredient chute section 33 characterized like this is inserted into the hollow part of the passage constituting member 35 from above, whereby the hollow part constitutes a passage 351 through which the ground coffee beans and the mixing hot water (hot water) pass and having a water repellent inner wall surface, although details will be described below.

A part of an upper end of the hollow part of the passage constituting member 35 is joined to an exhaust duct 44 in such a manner as to be partitioned from the ingredient chute section 33. The exhaust duct 44 not only communicates with the passage constituting member 35, but also communicates with the interior of the cylinder 341 via the passage constituting member 35 in a case where the cylinder 341 is attached to the attachment region 312. As illustrated in FIG. 2, the exhaust duct 44 characterized like this is provided with an exhaust fan (exhaust means) 46. The exhaust fan 46 is driven in accordance with a command given from the control section 12, and when driven, discharges the internal air and the like of the cylinder 341 to the outside through the exhaust duct 44.

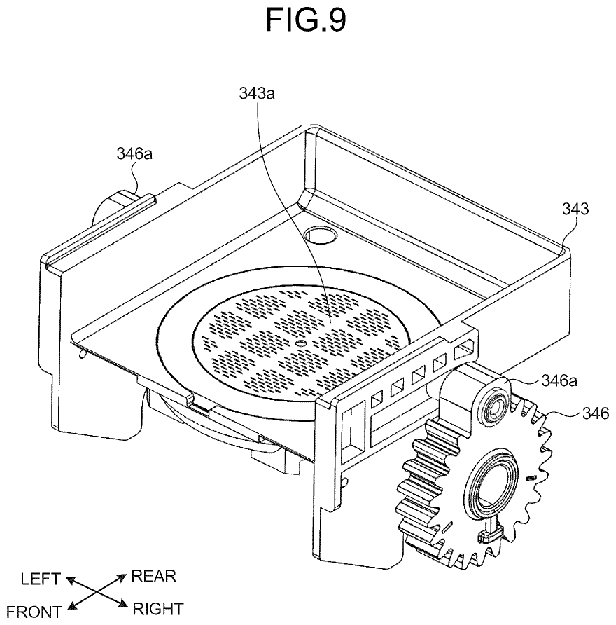

The filter block 343 has a substantially box shape provided so as to be movable in the up-down direction in the lower region of the attachment region 312. As illustrated in FIG. 9, the upper surface of the filter block 343 has a size sufficient to close the lower surface opening 341a of the cylinder 341. The filter block 343 is provided with a disk-shaped metal mesh member 343a having a plurality of holes, and is connected to a beverage supply path 48 communicating with these holes. The beverage supply path 48 is connected with a beverage supply pipe so as to join the filter block 343 and the nozzle 22b to each other.

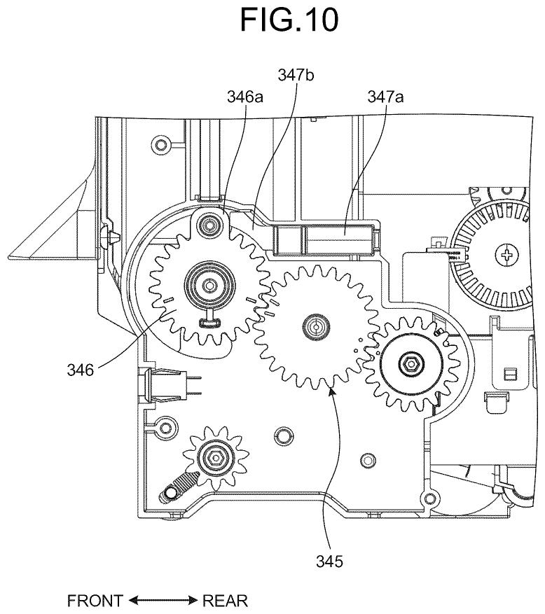

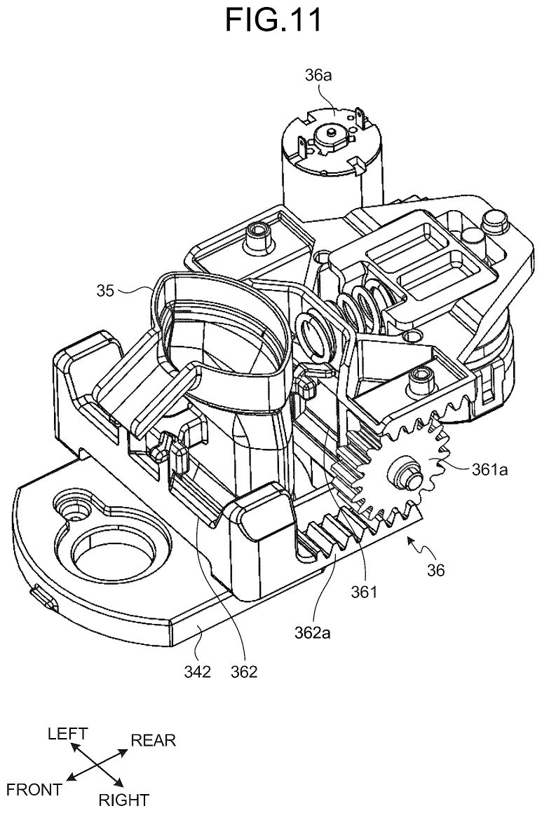

The filter block 343 moves such that, when a filter block drive section 344 being an actuator is driven in accordance with a command given from the control section 12, as illustrated in FIG. 10, a block gear 346 provided on the left and right side portions of the filter block 343 pivots about the central axis via a linkage gear 345 provided in the extractor main body 31, thereby moving the filter block 343 in the up-down direction. That is, the filter block 343 moves up and down in such a manner as to approach and separate from the cylinder 341 attached to the attachment region 312. When moving upward, the filter block 343 presses and closes the lower surface opening 341a of the cylinder 341.

Meanwhile, the block gear 346 is provided with a radially outer portion 346a that protrudes outward in a radial direction. As illustrated in FIG. 9, when the radially outer portion 346a protrudes upward, the filter block 343 is in a most raised state. When the radially outer portion 346a protrudes downward, the filter block 343 is in a most lowered state.

As illustrated in FIG. 10, the extractor main body 31 has a stopper member 347b biased forward by a compression spring 347a, and the stopper member 347b can come in contact with the radially outer portion 346a protruding upward.

As illustrated in FIG. 11, the pinch mechanism 36 is provided on the upper side of the lid member 342. The pinch mechanism 36 has a configuration in which a first pinch component 361 and a second pinch component 362 each extending in the left-right direction are disposed to be separated from each other in the front-rear direction, and the passage constituting member 35 is disposed between the first pinch component 361 and the second pinch component 362.

Both left and right ends of the first pinch component 361 have a pinion 361a which is rotatably provided, while both left and right ends of the second pinch component 362 have a rack 362a extending in the front-rear direction, with the rack 362a meshing with the pinion 361a.

The first pinch component 361 has, its rear end, a long hole 361b formed to have its the longitudinal direction aligned with the left-right direction, with a projection 363a of a cam portion 363 inserted into the long hole 361b from below. The cam portion 363 is provided on the lower side of the first pinch component 361. When a pinch motor 36a being an actuator is driven in accordance with a command given from the control section 12, the cam portion 363 rotates about an axis, which is a rotation shaft extending in the up-down direction defined as the axis. The cam portion 363 has a projection 363a protruding upward at a position eccentric from the rotation shaft.

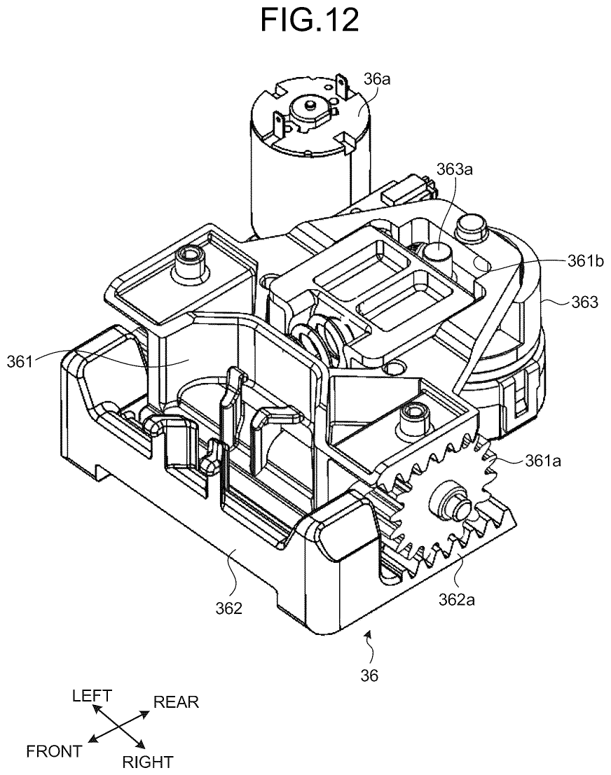

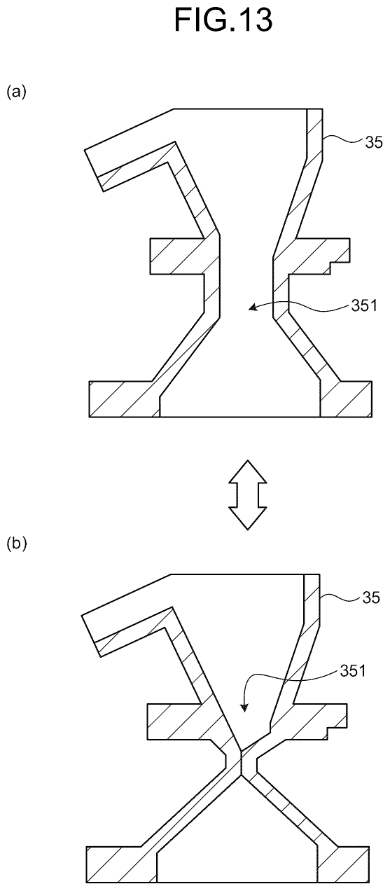

In the pinch mechanism 36 characterized like this, the projection 363a of the cam portion 363, in a normal state, is disposed on the rear side of the rotation shaft of the cam portion 363, thereby locating the first pinch component 361 and the second pinch component 362 most separated from each other. On the other hand, when the pinch motor 36a is driven, the cam portion 363 rotates so that the projection 363a is disposed on the front side of the rotation shaft, whereby the first pinch component 361 moves forward. As the pinion 361a rotates by the first pinch component 361 moving forward in this manner, the rack 362a to be meshed is displaced rearward, whereby the second pinch component 362 moves rearward. That is, the pinch mechanism 36 operates such that, when the pinch motor 36a is driven, the first pinch component 361 and the second pinch component 362 move in such a manner as to approach each other, and when the projection 363a is disposed on the front side of the rotation shaft, the first pinch component 361 and the second pinch component 362 are in the highest proximity to each other as illustrated in FIG. 12.

In this manner, since the first pinch component 361 and the second pinch component 362 are most separated from each other in the normal state, the pinch mechanism 36 does not act on the passage constituting member 35 at all as illustrated in part (a) of FIG. 13. On the other hand, when the first pinch component 361 and the second pinch component 362 are in the highest proximity to each other by the drive of the pinch motor 36a, the pinch mechanism 36 elastically deforms the lower portion of the passage constituting member 35 to bring a part of the passage 351 (hollow part) into a closed state as illustrated in part (b) of FIG. 13. By bringing a part of the passage 351 into the closed state in this manner, the passage 351 restricts the ground coffee beans from passing through the passage 351. Incidentally, the portion where the pinch mechanism 36 pinches the passage constituting member 35 to close a part of the passage 351 is a lower portion of the passage constituting member 35, that is, a portion below the region where the ingredient chute section 33 is inserted.

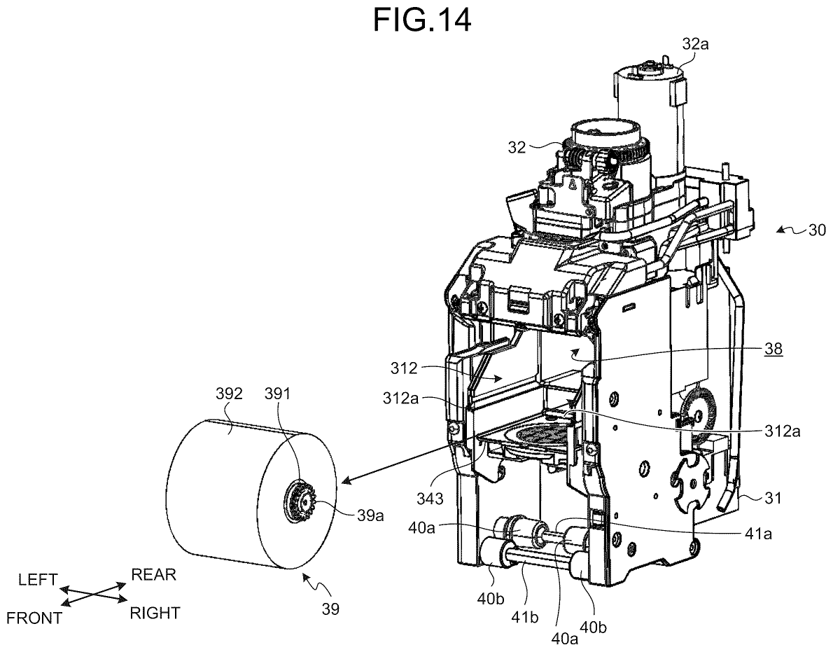

The filter storage portion 38 is formed in a rear region of the attachment region 312 in the extractor main body 31, that is, in a deep region of the attachment region 312. The filter storage portion 38 is a portion that rotatably supports and stores a filter roll 39. As illustrated in FIG. 14, the filter roll 39 has a configuration in which a paper filter 392 is wound around a roll core 391 as a winding center, and a filter shaft 39a is detachably attached to the roll core 391.

On each left and right side of the attachment region 312 being a front region of the filter storage portion 38, a guide portion 312a for guiding the filter shaft 39a is formed. The guide portion 312a makes it possible to detachably attach the filter roll 39 to the filter storage portion 38 through the attachment region 312 from which the cylinder 341 has been removed.

As illustrated in FIG. 2, the filter storage portion 38 characterized like this includes an encoder 38a and a distance measuring sensor 38b. The encoder 38a detects the rotation of the filter roll 39, and outputs a result of the detection to the control section 12. The distance measuring sensor 38b is installed at a position separated from the filter roll 39 to the outside in the radial direction of the filter roll 39 so as to detect a distance between the sensor itself and the filter roll 39 and output a result of the detection to the control section 12.

The paper roller portion 40 is installed in a lower region of the filter block 343 in the extractor main body 31. The paper roller portion 40 pinches the paper filter 392, which is drawn out from the filter roll 39 stored in the filter storage portion 38 and extending between the cylinder 341 and the filter block 343 while being in contact with the guide piece 341e of the cylinder 341.

The paper roller portion 40 characterized like this includes a driving roller 40a and a driven roller 40b. The driving roller 40a is a disk-shaped roller provided as a left-right pair and joined to a driving rotation shaft 41a, as a common shaft, in such a manner that inner surfaces of the rollers face each other. These driving rollers 40a are each provided, on their outer circumferential portions, with a tooth portion (not illustrated) protruding outward in the radial direction. The driving roller 40a rotates in a counterclockwise direction as viewed from the right around the driving rotation shaft 41a when a forward rotation drive command is given from the control section 12 to a roller drive section 40M being an actuator, and rotates in a clockwise direction as viewed from the right around the driving rotation shaft 41a when a reverse rotation drive command is given.

The driven roller 40b is a disk-shaped roller provided as a left-right pair and joined to a driven rotation shaft 41b, as a common shaft, in such a manner that inner surfaces of the rollers face each other, at a position relatively lower than the driving roller 40a. These driven rollers 40b are each provided, on their outer circumferential portions, with a tooth portion (not illustrated) protruding outward in the radial direction. The driven roller 40b characterized like this has a part of its tooth portion meshing with a part of the tooth portion of the corresponding driving roller 40a to pinch the paper filter 392, so as to rotate about its own central axis together with the rotation of the driving roller 40a.

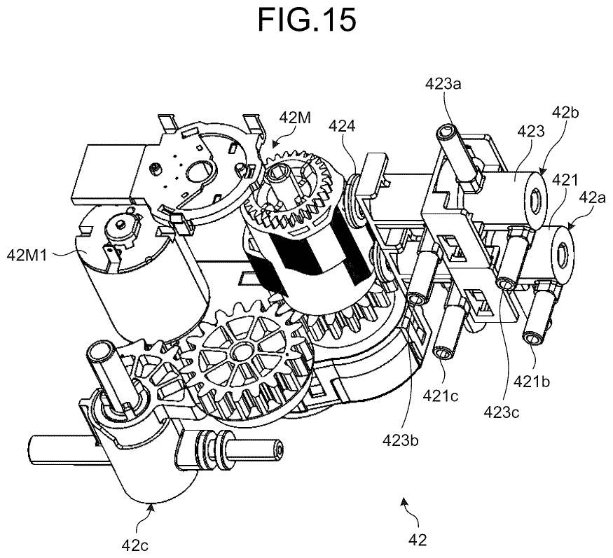

As illustrated in FIGS. 2 and 3, the valve group 42 is installed on the upper rear side of the extractor main body 31. As also illustrated in FIG. 15, the valve group 42 includes an air switching valve (switching valve) 42a, a hot water valve 42b, and a coffee valve 42c.

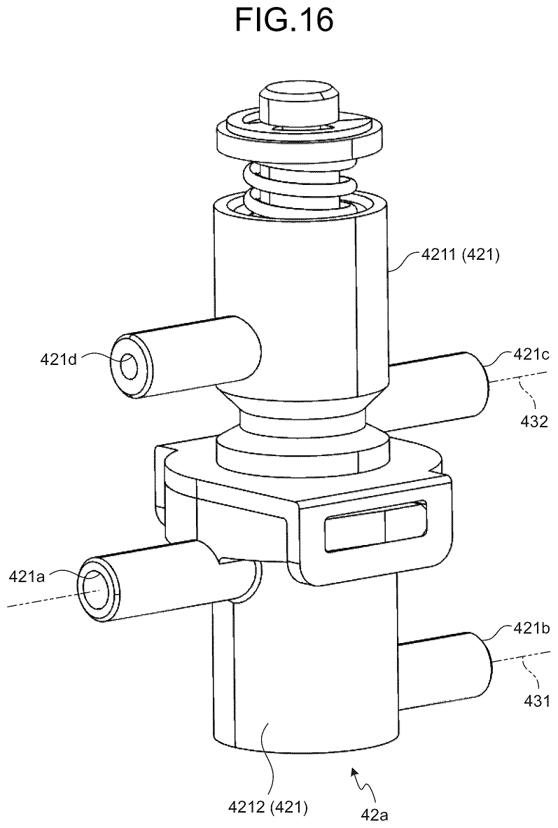

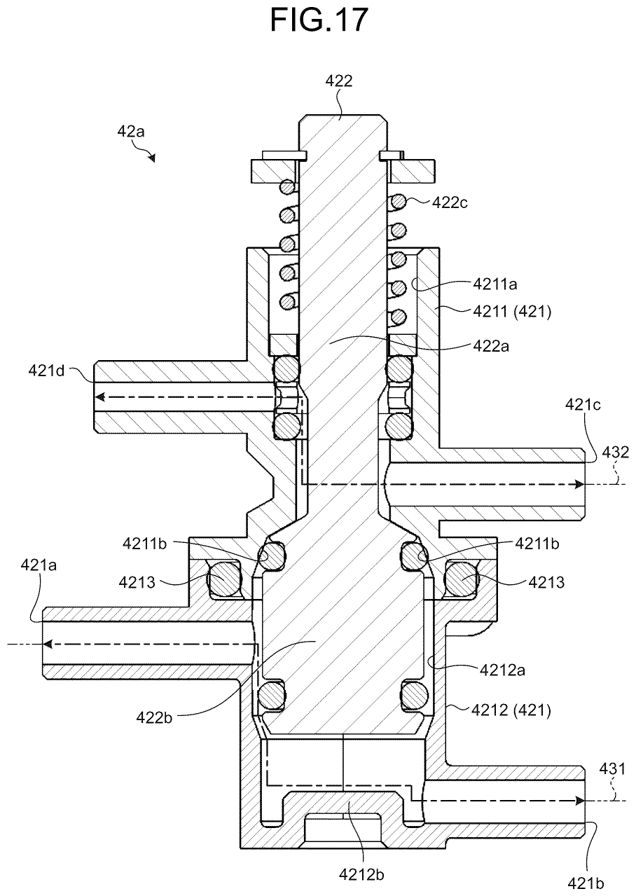

FIGS. 16 and 17 each illustrate the air switching valve 42a illustrated in FIG. 15. FIG. 16 is a perspective view illustrating an external configuration thereof, and FIG. 17 is a longitudinal sectional view illustrating an internal structure thereof. As also illustrated in FIGS. 16 and 17, the air switching valve 42a includes a switching valve case 421 and a switching valve shaft 422.

The switching valve case 421 includes a first case component 4211 and a second case component 4212 joined with each other. The first case component 4211 has a substantially cylindrical shape. The second case component 4212 has a substantially bottomed cylindrical shape, having a hollow part 4212a at an internal portion communicating with a hollow part 4211a of the first case component 4211. Here, the inner diameter of the hollow part 4212a of the second case component 4212 is larger than the inner diameter of the hollow part 4211a of the first case component 4211. In addition, the first case component 4211 is formed in a tapered shape in which an inner diameter of a boundary 4211b with the second case component 4212 gradually decreases toward a direction separating from the second case component 4212. The first case component 4211 and the second case component 4212 are joined to each other via an O-ring 4213 at a portion not exposed to the hollow part 4211a or 4212a, thereby maintaining mutual airtightness across the hollow parts 4211a and 4212a.

The switching valve case 421 characterized like this includes a plurality (four) ports: an air introduction port (first port) 421a; a stirring air ejection port (second port) 421b; an extraction air ejection port (third port) 421c; and an opening port (fourth port) 421d. These ports communicate with the hollow parts 4211a and 4212a, individually.

The air introduction port 421a is formed in the second case component 4212 and is connected to the air supply path 71 of the air supply section 70. The stirring air ejection port 421b is formed in the second case component 4212 and is connected to a stirring air supply path 431. The stirring air supply path 431 is constituted with a stirring air supply pipe, and is connected to the coffee valve 42c.

The extraction air ejection port 421c is formed in the first case component 4211 and is connected to an extraction air supply path 432. The extraction air supply path 432 includes an extraction air supply pipe, and is connected to a portion of the lid member 342 that covers the first upper surface opening 341b. An opening port 421d, formed in the first case component 4211, is an opening for opening the interior of the hollow part 4211a.

The switching valve shaft 422 is provided in the hollow parts 4211a and 4212a of the switching valve case 421 so as to be displaceable in the axial direction of the switching valve case 421. The switching valve shaft 422 includes a small diameter portion 422a and a large diameter portion 422b having different outer diameters, and is provided with a plurality of O-rings.

The maximum diameter portion of the small diameter portion 422a is smaller than the inner diameter of the hollow part 4211a of the first case component 4211, and the outer diameter of the large diameter portion 422b is larger than the inner diameter of the hollow part 4211a of the first case component 4211 and smaller than the inner diameter of the hollow part 4212a of the second case component 4212.

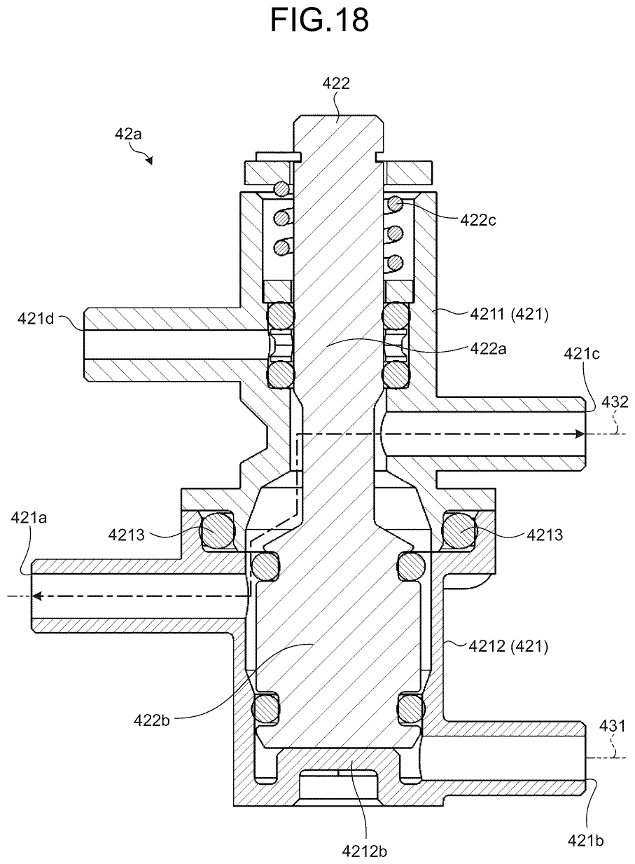

The switching valve shaft 422 characterized like this is disposed at a standby position (first position) by the biasing force of a switching valve shaft spring 422c as a biasing means (refer to FIG. 17). When disposed at a standby position, one end of the small diameter portion 422a protrudes outward from the switching valve case 421, and a part of the large diameter portion 422b is in contact with the boundary 4211b between the first case component 4211 and the second case component 4212. When the switching valve shaft 422, with its one end portion pressed, is displaced against the biasing force of the switching valve shaft spring 422c so as to be disposed at an advance position (second position), the other end of the switching valve shaft 422 comes in contact with a bottom portion 4212b of the second case component 4212 as illustrated in FIG. 18.

In the air switching valve 42a characterized like this, when the switching valve shaft 422 is disposed at the standby position, the air introduction port 421a and the stirring air ejection port 421b communicate with each other, while the extraction air ejection port 421c and the opening port 421d communicate with each other. On the other hand, when the switching valve shaft 422 is disposed at the advance position, the air introduction port 421a and the extraction air ejection port 421c communicate with each other, while the stirring air ejection port 421b and the opening port 421d do not communicate with each other, namely, are in a non-communication state.

Although the detailed configuration of the hot water valve 42b is omitted, similarly to the air switching valve 42a, there is provided a hot water valve shaft 424 (refer to FIG. 15) in a hollow part (not illustrated) of a hot water valve case 423 so as to be displaceable in the axial direction of the hot water valve case 423. The hot water valve 42b includes a plurality (three) ports, namely, a hot water introduction port 423a, a mixing hot water ejection port 423b, and an addition hot water ejection port 423c.

The hot water introduction port 423a is connected to a hot water supply path 64 (hot water supply pipe) of the hot water supply section 60. The mixing hot water ejection port 423b is connected to a mixing hot water supply path 433. The mixing hot water supply path 433 includes a mixing hot water supply pipe, and is connected to a mixing hot water nozzle 434 formed in the ingredient chute section 33 as also illustrated in FIG. 7.

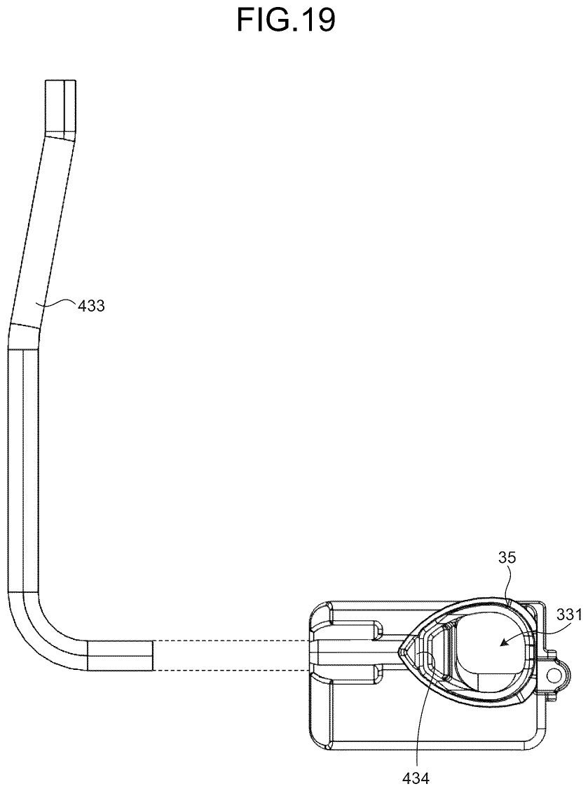

Here, as illustrated in FIG. 19, the mixing hot water nozzle 434 is provided in such a manner as to face the ingredient passage 331 in the ingredient chute section 33, and ejects mixing hot water in a fan shape diagonally downward. More specifically, as illustrated in FIG. 8, the mixing hot water nozzle 434 ejects the mixing hot water in such a manner as to close a part of the ingredient passage 331 in the ingredient chute section 33.

With this configuration, the extractor 30 mixes the ground coffee beans and the mixing hot water in the air at the ingredient chute section 33, and allows the mixture to collide with an inner wall surface of the ingredient passage 331 to drop downward thereafter along the inner wall surface with no contact with the inner wall surface of the passage constituting member 35.

Meanwhile, as illustrated in FIGS. 7 and 8, the extractor 30 has an intake port 45 for sucking air above a portion to which the ground coffee beans are ejected from the grinder 32 to the ingredient chute section 33.

The addition hot water ejection port 423c is connected to the addition hot water supply path 435. The addition hot water supply path 435 includes an addition hot water supply pipe, and is connected to an addition hot water nozzle (not illustrated) formed in a portion of the lid member 342 covering the first upper surface opening 341b. Here, the addition hot water nozzle ejects the addition hot water supplied through the addition hot water supply path 435 downward like a shower.

The hot water valve 42b characterized like this has a configuration in which the hot water introduction port 423a and the mixing hot water ejection port 423b communicate with each other in a normal state and the hot water introduction port 423a and the addition hot water ejection port 423c come to communicate with each other when an external force is applied to displace the hot water valve shaft 424.

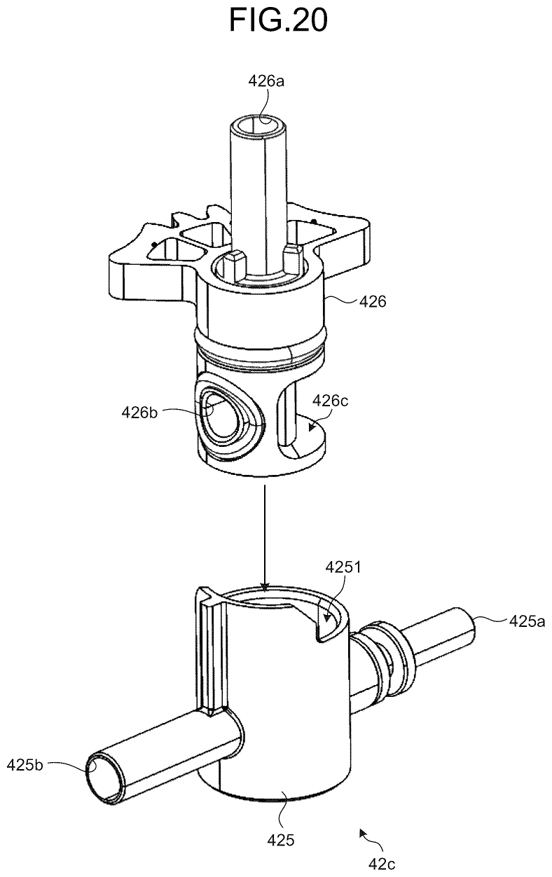

The coffee valve 42c is disposed in the middle of the beverage supply path 48. As illustrated in FIG. 20, the coffee valve 42c has an inner member 426 inserted into a hollow part of an outer member 425 being a bottomed cylindrical member. The outer member 425 is provided with a stirring air introduction port 425a and a coffee introduction port 425b. The inner member 426 includes a coffee ejection port 426a and also includes, at a lower portion, an inlet 426b communicating with the coffee ejection port 426a. At a lower portion of the inner member 426, there is provided an O-ring in such a manner as to surround the inlet 426b, and there is provided a notch 426c in a region excluding the inlet 426b.

The stirring air introduction port 425a is connected to the stirring air supply path 431. The coffee introduction port 425b is connected to the filter block 343 (brewer unit 34) through a part of the beverage supply path 48. The coffee ejection port 426a is connected to the nozzle 22b of the beverage supply section 22 through a part of the beverage supply path 48.

In the coffee valve 42c characterized like this, when the inlet 426b of the inner member 426 is disposed to face the coffee introduction port 425b, the coffee introduction port 425b and the coffee ejection port 426a communicate with each other. On the other hand, when the inner member 426 rotates about 90° about its own central axis, the notch 426c faces the coffee introduction port 425b and the stirring air introduction port 425a, allowing the stirring air introduction port 425a and the coffee introduction port 425b to communicate with each other.

In the valve group 42 characterized like this, as illustrated in FIG. 15, the air switching valve 42a, the hot water valve 42b, and the coffee valve 42c are linked with each other by a valve actuator 42M used in common. The valve actuator 42M includes a valve motor 42M1, which drives to rotate cams and gears so as to switch the communication states of individual ports of the air switching valve 42a, the hot water valve 42b, and the coffee valve 42c.

Meanwhile, the beverage supply path 48 connecting the coffee valve 42c and the filter block 343 has a three-way valve 47. The three-way valve 47 includes: an inlet connected to the beverage supply pipe joined to the filter block 343; a first outlet connected to the beverage supply pipe joined to the coffee valve 42c; and a second outlet connected to a drain path 471 provided in such a manner as to extend to the storage bucket 75. According to a command given from the control section 12, the three-way valve 47 is alternatively switched between: a first delivery state in which the inlet and the first outlet communicate with each other; and a second delivery state in which the inlet and the second outlet communicate with each other.

### Joint Section 63 and Cleaning Liquid Pump 82

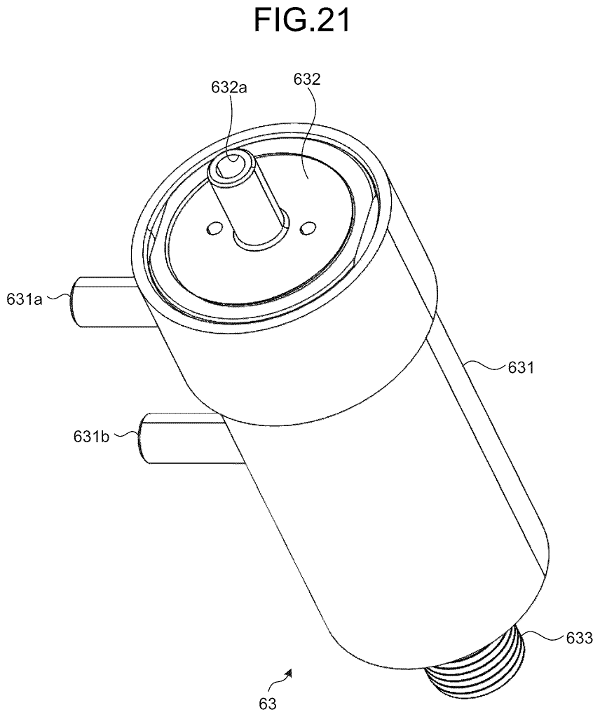

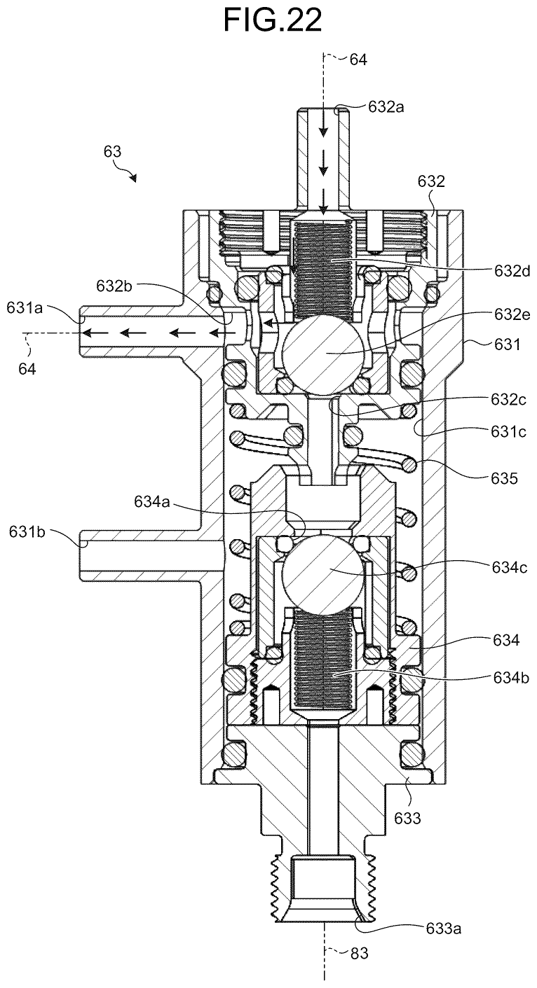

FIGS. 21 and 22 each illustrate the joint section 63 illustrated in FIG. 2. Specifically, FIG. 21 is a perspective view illustrating an external configuration of the joint section 63, and FIG. 22 is a longitudinal sectional view illustrating an internal structure of the joint section 63. As illustrated in FIGS. 21 and 22, the joint section 63 includes a joint body 631, a first flow path component 632, a closing member 633, and a second flow path component 634.

The joint body 631 has a cylindrical shape, and is provided with a delivery port 631a and a discharge port 631b. The delivery port 631a communicates with a hot water supply pipe of the hot water supply path 64, and more specifically, communicates with a hot water supply pipe connected to the hot water valve 42b. The discharge port 631b communicates with, for example, a discharge path extending to the storage bucket 75 although not explicitly illustrated in the drawing.

The first flow path component 632 is fixed in a hollow part 631c of the joint body 631, and more specifically, is fixed in the hollow part 631c in such a manner as to close an opening on one end side of the joint body 631. The first flow path component 632 includes a source hot water introduction port (first introduction port) 632a, a first ejection port 632b, and an inflow port 632c.

The source hot water introduction port 632a communicates with the hot water supply pipe of the hot water supply path 64, more specifically, communicates with the hot water supply pipe connected to the hot water supply pump 62. The first ejection port 632b is provided in such a manner as to communicate with the delivery port 631a. The inflow port 632c is formed at a position capable of facing the second flow path component 634, and is constantly closed by a first ball valve 632e biased by a first ball spring (first biasing means) 632d.

The closing member 633 is provided in such a manner as to close the opening on the other end side of the joint body 631. The closing member 633 has a cleaning liquid introduction port (second introduction port) 633a. The cleaning liquid introduction port 633a communicates with the cleaning liquid supply path 83 of the cleaning liquid supply section 80, and more specifically, is connected to a cleaning liquid supply pipe so as to be on the downstream side of the cleaning liquid pump 82.

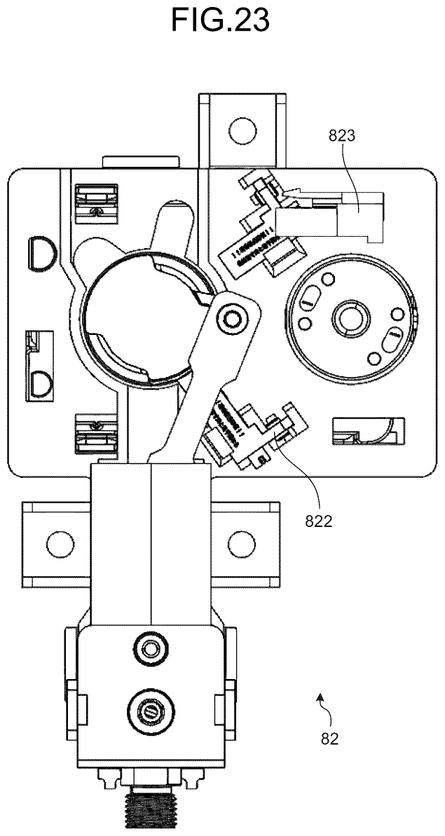

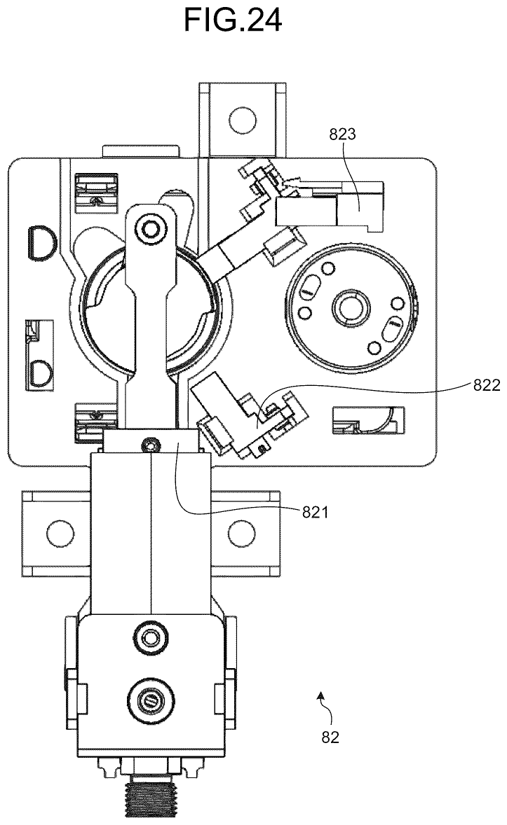

Here, the cleaning liquid pump 82 will be described. As illustrated in FIGS. 23 and 24, the cleaning liquid pump 82 is a piston pump that moves a piston 821 (refer to FIG. 24) up and down to repeat suction and ejection of the cleaning liquid from the cleaning liquid tank 81.

The cleaning liquid pump 82 characterized like this is driven in accordance with a command given from the control section 12, and moves the piston 821 upward when a quantitative bottom dead center sensor 822 using a sensor such as an optical sensor, for example, has detected that the piston 821 is at the bottom dead center, and moves the piston 821 downward when a quantitative top dead center sensor 823 using a sensor such as an optical sensor, for example, has detected that the piston 821 is at the top dead center, thereby obtaining a constant amount of up-down movement strokes of the piston 821 to eject a constant amount of cleaning liquid.

The second flow path component 634, with its interior communicating with the cleaning liquid introduction port 633a, is provided in the hollow part 631c of the joint body 631. The second flow path component 634 is provided in the hollow part 631c in such a manner as to approach and separate from the first flow path component 632. The second flow path component 634 has a second ejection port 634a. The second ejection port 634a is formed at a position capable of facing the first flow path component 632, more specifically, at a position capable of facing the inflow port 632c, and is constantly closed by a second ball valve 634c biased by a second ball spring (second biasing means) 634b.

The second flow path component 634 characterized like this is biased in such a manner as to be separated from the first flow path component 632 by a joint spring (third biasing means) 635 interposed between the second flow path component 634 and the first flow path component 632, determining a standby state position of the second flow path component 634.

In the joint section 63 characterized like this, when the second flow path component 634 is separated from the first flow path component 632, the inflow port 632c and the second ejection port 634a closed from each other are separated from each other. In this case, when hot water is introduced from the source hot water introduction port 632a by the drive of the hot water supply pump 62, hot water is circulated to the delivery port 631a via the first ejection port 632b and is delivered from the delivery port 631a.

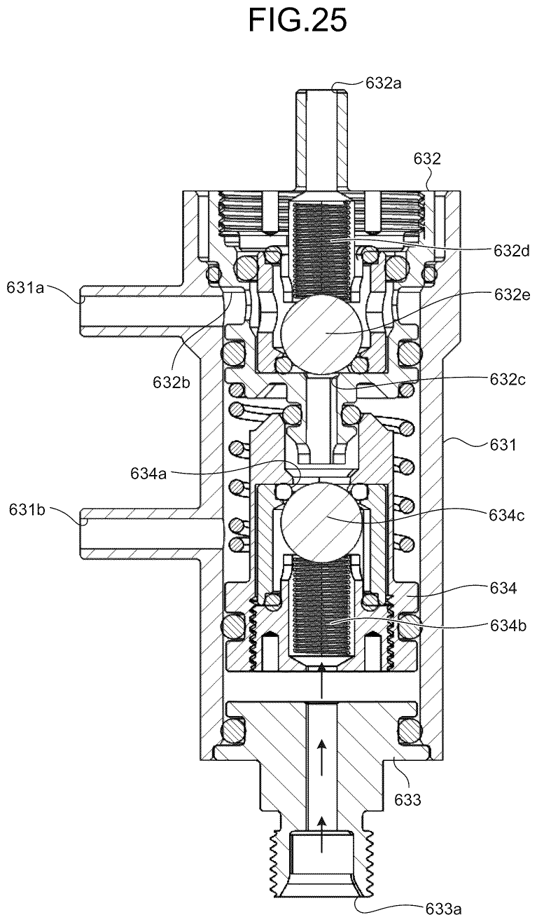

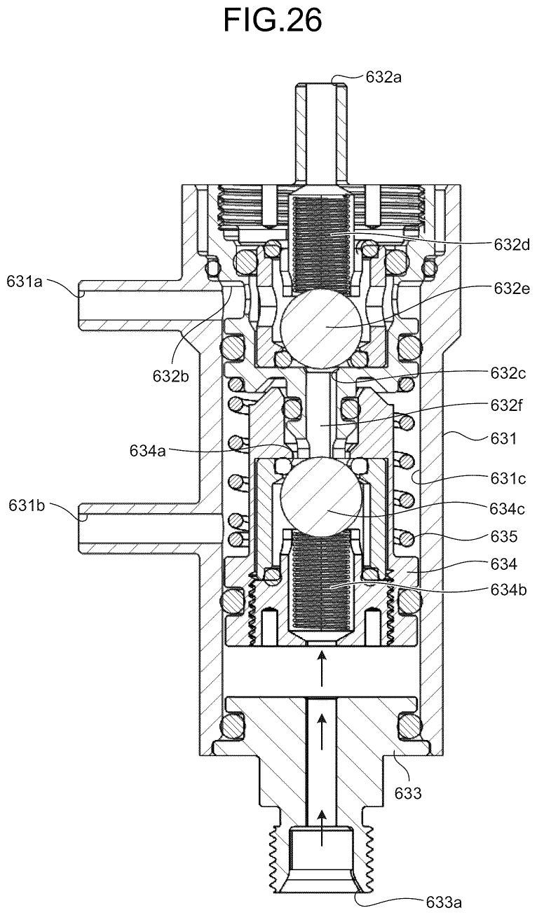

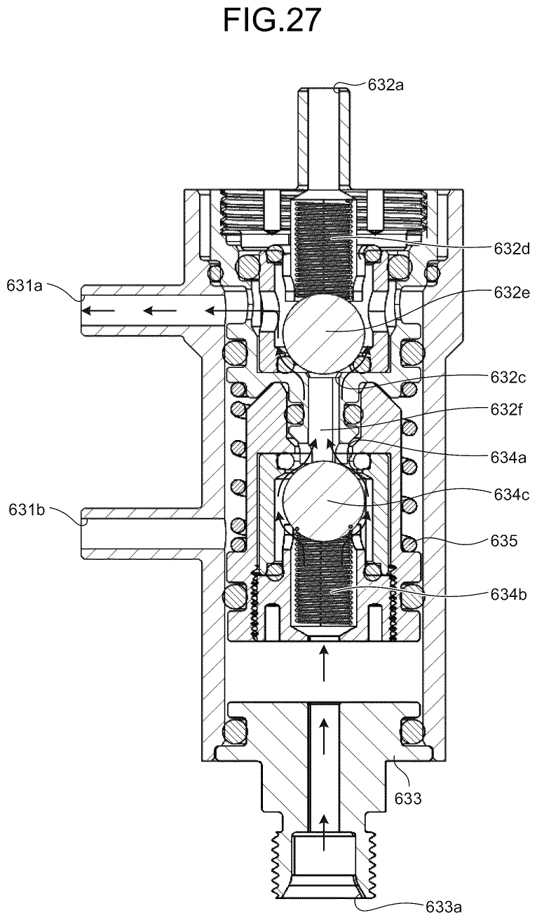

On the other hand, in the joint section 63, when the drive of the hot water supply pump 62 is stopped and the cleaning liquid is introduced from the cleaning liquid introduction port 633a by the drive of the cleaning liquid pump 82, as illustrated in FIG. 25, the second flow path component 634 is brought into proximity to the first flow path component 632 against the biasing force of the joint spring 635. As the second flow path component 634 is brought into proximity to the first flow path component 632 in this manner, as illustrated in FIG. 26, a protrusion 632f formed in the first flow path component 632 comes in contact with the second ball valve 634c. As the second flow path component 634 comes into further proximity to the first flow path component 632, as illustrated in FIG. 27, the second ball valve 634c is pressed against the protrusion 632f and retracts against the biasing force of the second ball spring 634b, thereby opening the second ejection port 634a to eject the cleaning liquid. The cleaning liquid ejected from the second ejection port 634a in this manner causes the first ball valve 632e to retract against the biasing force of the first ball spring 632d, thereby opening the inflow port 632c. This allows the cleaning liquid flowing in from the inflow port 632c to flow to the delivery port 631a via the first ejection port 632b so as to be delivered from the delivery port 631a.

When the introduction amount of the cleaning liquid is reduced by stopping the drive of the cleaning liquid pump 82, the inflow port 632c is closed by the first ball valve 632e, while the second ejection port 634a is closed by the second ball valve 634c. Subsequently, the second flow path component 634 moves in such a manner as to be separated from the first flow path component 632 by the biasing force of the joint spring 635, and is disposed at the standby state position.

In this manner, when hot water is introduced from the source hot water introduction port 632a by the drive of the hot water supply pump 62, the joint section 63 allows the hot water to flow to the delivery port 631a through the first ejection port 632b so as to be delivered from the delivery port 631a. On the other hand, when a cleaning liquid is introduced from the cleaning liquid introduction port 633a by the drive of the cleaning liquid pump 82, the joint section 63 allows the cleaning liquid to flow to the delivery port 631a through the second ejection port 634a, the inflow port 632c, and the first ejection port 632b in this order, so as to be delivered from the delivery port 631a.

### Supply Operation of Beverage Supply Apparatus

The beverage supply apparatus can supply coffee to the cup C placed on the stage 22a of the beverage supply section 22 as follows. As a premise, hot water is supposed to be stored in the hot water tank 61, and the air switching valve 42a is supposed to be in a state where the switching valve shaft 422 is disposed at the standby position, the air introduction port 421a and the stirring air ejection port 421b communicate with each other, while the extraction air ejection port 421c and the opening port 421d communicate with each other. In addition, the hot water valve 42b is in a state where the hot water introduction port 423a and the mixing hot water ejection port 423b communicate with each other, and the coffee valve 42c is in a state where the stirring air introduction port 425a and the coffee introduction port 425b communicate with each other. Furthermore, the three-way valve 47 is in the first delivery state.

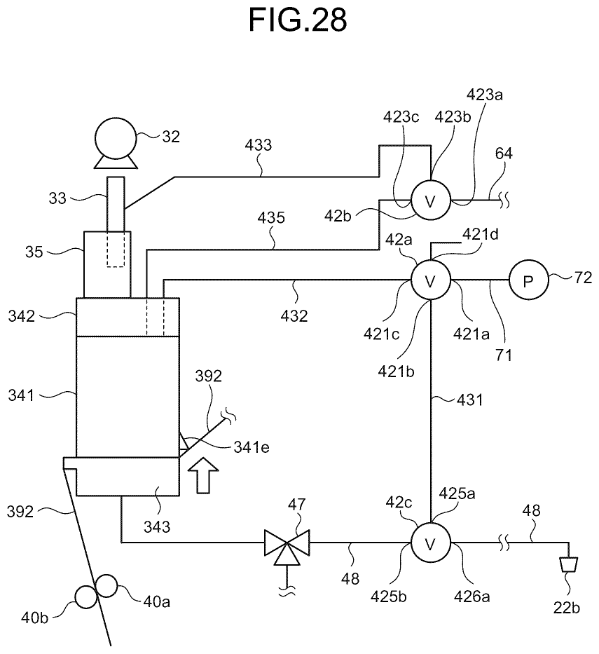

When a user performs a touch operation on the display section 21, a selling signal of the selected beverage is given to the control section 12. In response to this, the control section 12 gives a command to the filter block drive section 344 to move the filter block 343 upward as illustrated in FIG. 28, and then gives a drive command to the ingredient supply drive section 51a to cause the grinder 32 to dispense coffee beans in an amount corresponding to the beverage. The control section 12 stops the drive of the ingredient supply drive section 51a after a predetermined amount of coffee beans has been dispensed to the grinder 32.

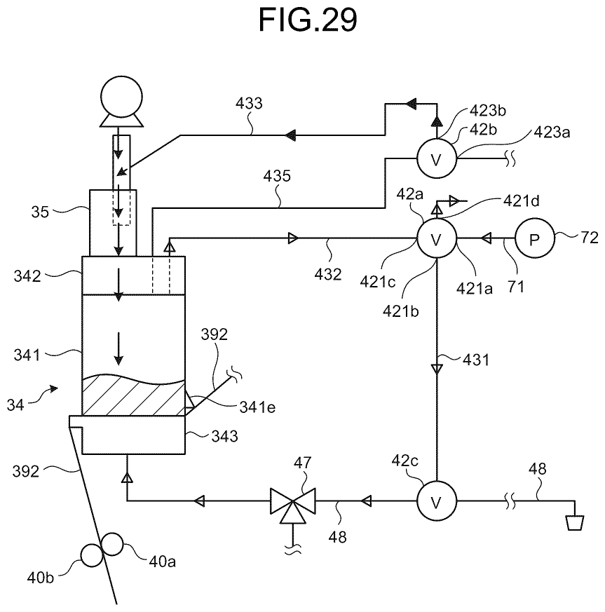

The control section 12 gives a drive command to the grinder drive section 32a while giving a drive command to the hot water supply pump 62. With these operations, as illustrated in FIG. 29, hot water in the hot water tank 61 is supplied to the mixing hot water nozzle 434 through the joint section 63, the hot water valve 42b, and the mixing hot water supply path 433, and is ejected as mixing hot water from the mixing hot water nozzle 434, and together with this, coffee beans are ground by the grinder 32 to be ejected to the ingredient chute section 33 as ground coffee beans. As a result, as illustrated in FIG. 8, at the ingredient chute section 33, the ground coffee beans fall and are mixed with the mixing hot water in the air, and a mixture of these collides with the inner wall surface of the ingredient passage 331 and then is fed into the cylinder 341. The control section 12 stops the drive of the grinder drive section 32a after ejecting a predetermined amount of ground coffee beans, and stops the drive of the hot water supply pump 62 after ejecting a predetermined amount of mixing hot water.

Thereafter, the control section 12 drives the air pump 72 to allow the pressurized air to be delivered to the air switching valve 42a (the air introduction port 421a to the stirring air ejection port 421b), the stirring air supply path 431, the coffee valve 42c, the beverage supply path 48, and the brewer unit 34 in this order to stir the mixture as illustrated in FIG. 29. The pressurized air thus delivered to the brewer unit 34 and used for stirring the mixture is delivered to the extraction air supply path 432 and the air switching valve 42a (extraction air ejection port 421c to the opening port 421d) in this order, and is released from the opening port 421d.

After stirring the mixture in this manner, the control section 12 gives a drive command to the valve actuator 42M to displace the hot water valve shaft 424 of the hot water valve 42b to allow the hot water introduction port 423a and the addition hot water ejection port 423c to communicate with each other.

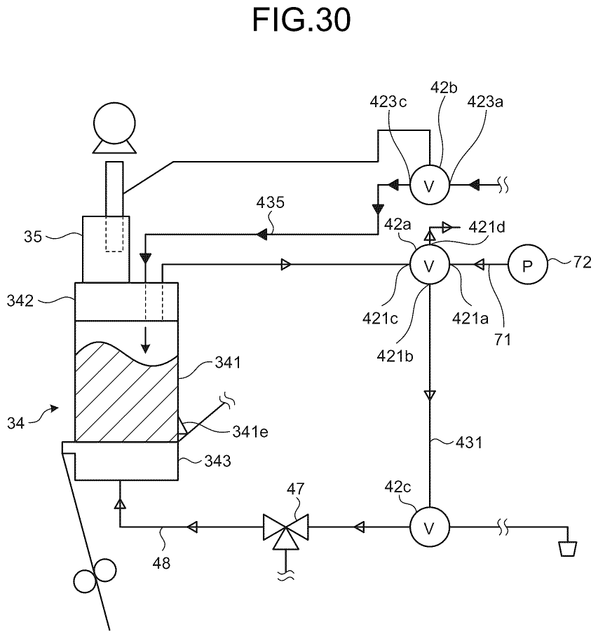

Thereafter, the control section 12 gives a drive command to the hot water supply pump 62, and as a result, as illustrated in FIG. 30, hot water in the hot water tank 61 is supplied to the addition hot water nozzle through the joint section 63, the hot water valve 42b, and the addition hot water supply path 435, and is ejected as addition hot water from the addition hot water nozzle like a shower. The pressurized air is delivered through the air switching valve 42a (the air introduction port 421a to the stirring air ejection port 421b), the stirring air supply path 431, the coffee valve 42c, the beverage supply path 48, and the brewer unit 34 in this order to further stir the mixture. The pressurized air thus delivered to the brewer unit 34 and used for stirring the mixture is delivered to the extraction air supply path 432 and the air switching valve 42a (extraction air ejection port 421c to the opening port 421d) in this order, and is released from the opening port 421d. The control section 12 stops the drive of the hot water supply pump 62 after ejecting a predetermined amount of addition hot water.

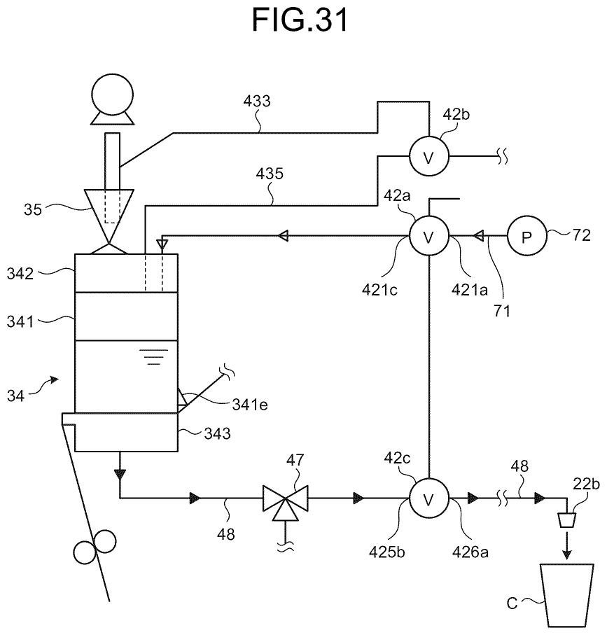

As illustrated in FIG. 31, after ejecting the predetermined amount of addition hot water, the control section 12 drives the pinch motor 36a to bring the first pinch component 361 and the second pinch component 362 into proximity to each other, thereby elastically deforming the lower portion of the passage constituting member 35 to bring a part of the passage 351 into the closed state. This makes it possible to hermetically seal the interior of the cylinder 341.

Along with this, the control section 12 gives a drive command to the valve actuator 42M, thereby displacing the switching valve shaft 422 of the air switching valve 42a to the advance position so as to allow the air introduction port 421a and the extraction air ejection port 421c to communicate with each other. In addition, the coffee introduction port 425b of the coffee valve 42c and the coffee ejection port 426a are allowed to communicate with each other.

With this configuration, as illustrated in FIG. 31, the pressurized air from the air pump 72 is delivered to the air switching valve 42a (the air introduction port 421a to the extraction air ejection port 421c), the extraction air supply path 432, and the brewer unit 34 in this order to extract coffee, and the extracted coffee is supplied to the nozzle 22b via the beverage supply path 48 and ejected from the nozzle 22b to the cup C.

When a predetermined amount of coffee is ejected and supplied to the cup C, the control section 12 stops the drive of the air pump 72, and together with this, gives a drive command to the valve actuator 42M to displace the switching valve shaft 422 of the air switching valve 42a to the standby position, allows the air introduction port 421a and the stirring air ejection port 421b to communicate with each other, allows the extraction air ejection port 421c and the opening port 421d to communicate with each other, and allows the stirring air introduction port 425a of the coffee valve 42c and the coffee introduction port 425b to communicate with each other. This makes it possible for the user to take out the cup C from the beverage supply section 22 by swinging the opening/closing door 23 in the opening direction. The pressurized air used for extraction is delivered in the order of the extraction air supply path 432 and the air switching valve 42a (the extraction air ejection port 421c to the opening port 421d), and is released from the opening port 421d, thereby making it possible to reduce the internal pressure of the brewer unit 34. Furthermore, the control section 12 drives the pinch motor 36a to separate the first pinch component 361 and the second pinch component 362 from each other, thereby elastically deforming the passage constituting member 35 to the original state and canceling the closed state.

Thereafter, the control section 12 gives a command to the filter block drive section 344 to lower the filter block 343. At this time, extraction residues K is placed on the paper filter 392 disposed above the filter block 343.

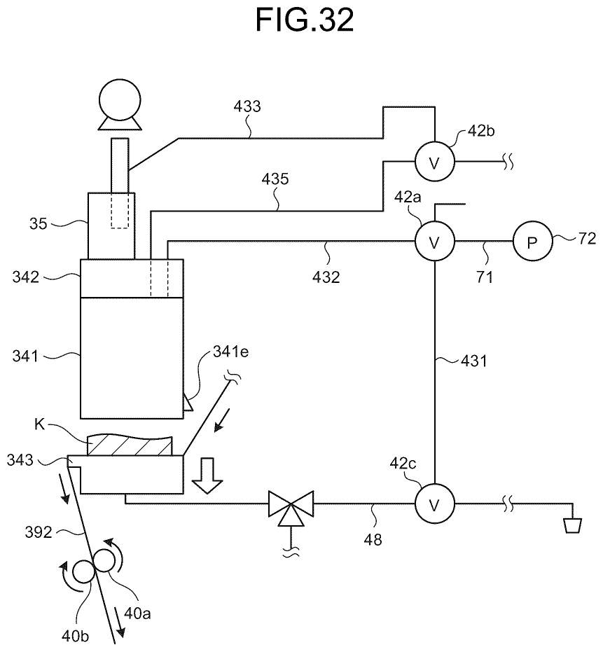

After lowering the filter block 343, the control section 12 applies, as illustrated in FIG. 32, a forward rotation drive command to the roller drive section 40M to rotate the driving roller 40a in the counterclockwise direction as viewed from the right side so as to perform a forward rotation drive of the paper roller portion 40, and thereby feeds out the paper filter 392 from the filter roll 39.

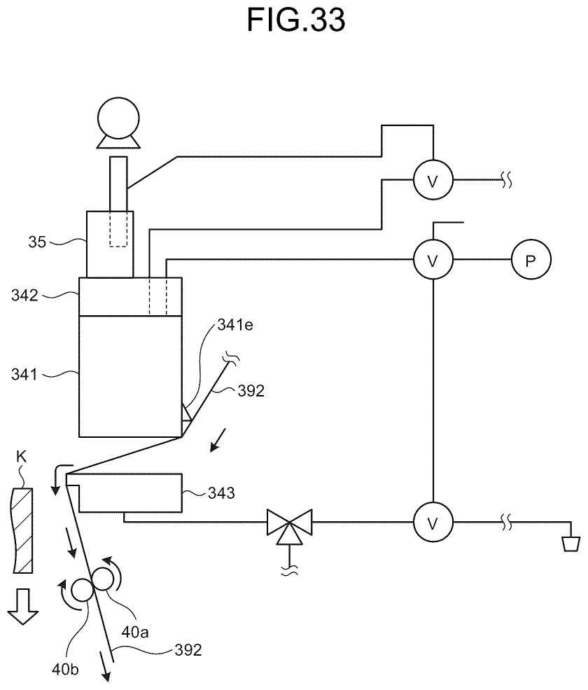

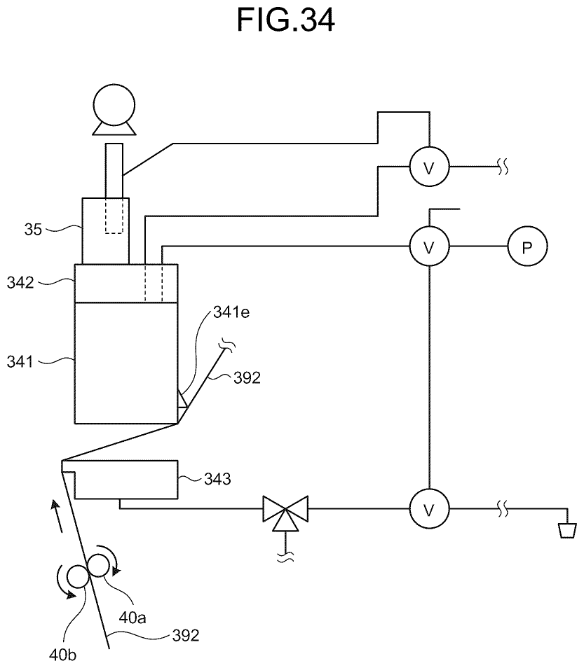

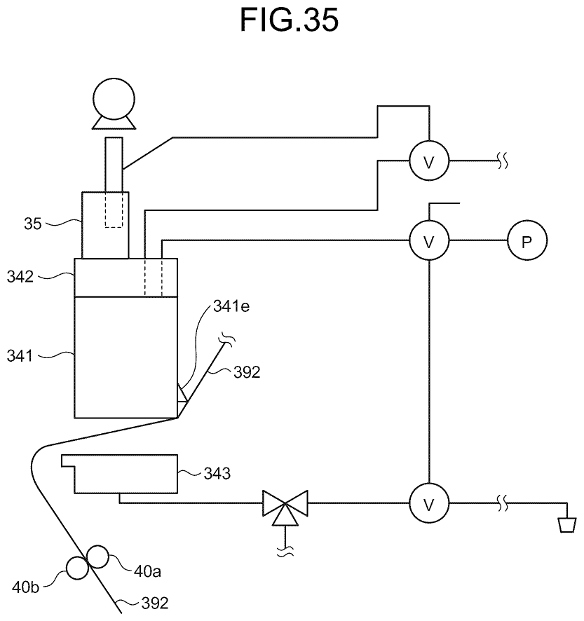

In this manner, as illustrated in FIG. 33, when the extraction residues K are removed from the upper region of the filter block 343 and discharged into the storage bucket 75, the control section 12 gives a reverse rotation drive command to the roller drive section 40M to rotate the driving roller 40a in the clockwise direction as viewed from the right side, thereby reversely rotating the paper roller portion 40, as illustrated in FIG. 34. With this operation, the paper filter 392 is loosened as illustrated in FIG. 35.

Meanwhile, although not included in the description of coffee extraction above, the control section 12 drives the exhaust fan 46 at the time of coffee extraction. As described above, the intake port 45 for sucking air is formed above the portion to which the ground coffee beans are ejected from the grinder 32 to the ingredient chute section 33. Accordingly, by the drive of the exhaust fan 46, the air sucked from the intake port 45 is discharged to the outside through the exhaust duct 44 after passing through the ingredient passage 331, and the air inside the cylinder 341 is discharged to the outside through the exhaust duct 44 without passing through the ingredient passage 331 as indicated by two-dot chain arrows in FIG. 8. This makes it possible to prevent steam from being delivered to the portion of grinder 32 to which the ground coffee beans are ejected. The control section 12 also reduces the rotation speed of the exhaust fan 46 when the ground coffee beans are ejected from the grinder 32.

When cleaning the brewer unit 34 and the like after extracting the coffee, the control section 12 may preferably drive the valve actuator 42M to bring each valve into a predetermined state, and then drive the cleaning liquid pump 82. With this operation, a fixed amount of cleaning liquid is ejected by the drive of the cleaning liquid pump 82, and the ejected cleaning liquid is delivered from the joint section 63 to the hot water supply path 64, and then delivered to and clean the brewer unit 34. The cleaning liquid delivered to the brewer unit 34 in this manner flows through the drain path 471 via the three-way valve 47 in the second delivery state and is discharged to the storage bucket 75. After the cleaning liquid is delivered, the control section 12 drives the hot water supply pump 62 to deliver the hot water in the hot water tank 61 from the joint section 63 to the hot water supply path 64, and thereafter deliver the hot water as rinse water to the brewer unit 34. The hot water thus delivered as rinse water flows through the drain path 471 via the three-way valve 47 in the second delivery state, and is discharged to the storage bucket 75.

The beverage supply apparatus described above has the following operational effects.

In the air switching valve 42a constituting the beverage supply apparatus, the switching valve shaft 422 includes the small diameter portion 422a and the large diameter portion 422b having different outer diameters, while the switching valve case 421 includes: the first case component 4211 in which the inner diameters of the hollow parts 4211a and 4212a are smaller than the outer diameter of the large diameter portion 422b; and the second case component 4212 in which the inner diameters of the hollow parts 4211a and 4212a are larger than the outer diameter of the large diameter portion 422b, with the case components 4211 and 4212 joined to each other. This configuration makes it possible to prevent the switching valve shaft 422 from coming out of the switching valve case 421.

In the air switching valve 42a, when the switching valve shaft 422 is disposed at the standby position, the air introduction port 421a and the stirring air ejection port 421b communicate with each other, and the extraction air ejection port 421c and the opening port 421d communicate with each other. On the other hand, when the switching valve shaft 422 is disposed at the advance position, only the air introduction port 421a and the extraction air ejection port 421c communicate with each other. Therefore, in the use for supplying pressurized air, there is no need to have a dedicated valve for releasing the pressurized air delivered to the brewer unit, unlike the related-art techniques. This can decrease the number of components, leading to reduction of the manufacturing cost.

In addition, since the air switching valve 42a is driven by the valve actuator 42M commonly used by the hot water valve 42b and the coffee valve 42c, this also contributes to reduction of the manufacturing cost due to the decreased number of components.

Furthermore, the air switching valve 42a is formed in a tapered shape in which the inner diameter of the boundary 4211b between the first case component 4211 and the second case component 4212 gradually decreases toward a direction separating from the second case component 4212, making it possible to buffer the impact when the switching valve shaft 422 comes into contact.

Furthermore, the air switching valve 42a has a configuration in which the first case component 4211 and the second case component 4212 are joined to each other via the O-ring 4213 at a portion not exposed to the hollow parts 4211a and 4212a so as to maintain mutual airtightness between the hollow parts 4211a and 4212a, making it possible to sufficiently secure the flow paths in the hollow parts 4211a and 4212a.

The joint section 63 constituting the beverage supply apparatus includes: the joint body 631 having a cylindrical shape and provided with the delivery port 631a and the discharge port 631b; the first flow path component 632 fixed in the hollow part 631c of the joint body 631 and having the source hot water introduction port 632a, the first ejection port 632b communicating with the delivery port 631a, and the inflow port 632c constantly closed by the first ball valve 632e biased by the first ball spring 632d; the closing member 633 provided in such a manner as to close the opening on the other end side of the joint body 631 and having the cleaning liquid introduction port 633a; the second flow path component 634 provided, with its interior communicating with the cleaning liquid introduction port 633a, in the hollow part 631c of the joint body 631 in such a manner as to approach and separate from the first flow path component 632 and including the second ejection port 634a constantly closed by the second ball valve 634c biased by the second ball spring 634b; and the joint spring 635 that is interposed between the first flow path component 632 and the second flow path component 634 and biases the second flow path component 634 in such a manner as to be separated from the first flow path component 632. With this configuration, when hot water is introduced from the source hot water introduction port 632a, the hot water is controlled to flow to the delivery port 631a through the first ejection port 632b so as to be delivered from the delivery port 631a. On the other hand, when a cleaning liquid is introduced from the cleaning liquid introduction port 633a, the second flow path component 634 comes into proximity to the first flow path component 632 against the biasing force of the joint spring 635, whereby the second ball valve 634c is pressed against the protrusion 632f formed in the first flow path component 632 to retract against the biasing force of the second ball spring 634b, thereby opening the second ejection port 634a to eject the cleaning liquid, and the first ball valve 632e is retracted against the biasing force of the first biasing means by the ejected cleaning liquid to open the inflow port 632c. This allows the cleaning liquid flowing in from the inflow port 632c to flow to the delivery port 631a via the first ejection port 632b so as to be delivered from the delivery port 631a. Consequently, there is no need to selectively mount one of the source liquid connector and the cleaning connector, unlike the related-art techniques, facilitating the cleaning work of the hot water supply path 64 and the like.

Moreover, since the first flow path component 632 and the second flow path component 634 are separated from each other in a normal state, there is no possibility that the cleaning liquid enters the hot water supply path 64 unless the cleaning liquid is introduced from the cleaning liquid introduction port 633a with a sufficient pressure. In addition, even if the second ejection port 634a is insufficiently closed by the second ball valve 634c due to some failure or the like, the cleaning liquid ejected from the second ejection port 634a is to be discharged to the outside from the discharge port 631b, and the internal pressure of the second flow path component 634 is reduced, having no possibility that the second flow path component 634 comes into proximity to the first flow path component 632 against the biasing force of the joint spring 635.

In the extractor 30 constituting the beverage supply apparatus, the passage constituting member 35, disposed in such a manner as to have its interior communicating with the second upper surface opening 341c of the cylinder 341, constitutes the passage 351 through which the ground coffee beans and the mixing hot water pass, and the passage 351 can be closed by elastic deformation of the passage constituting member 35 by an external force, making it possible to suppress scattering of the ingredient such as the ground coffee beans from the cylinder 341.

The extractor 30 constituting the beverage supply apparatus has a configuration in which the filter storage portion 38 is provided in the rear region of the attachment region 312 of the cylinder 341, and the filter roll 39 is detachable from the filter storage portion 38 through the attachment region 312 in a case where the cylinder 341 has been removed. This eliminates the necessity of providing a replenishment port and a replenishment door dedicated to the filter roll, unlike the related-art techniques, making it possible to facilitate replacement of the filter roll 39 while suppressing an increase in the manufacturing cost.

In particular, the guide portion 312a that guides the filter shaft 39a is formed in the attachment region 312. Therefore, when attaching/detaching the filter roll 39, it is only necessary to allow the filter shaft 39a to pass through the guide portion 312a, leading to further facilitation of the replacement work of the filter roll 39.

In addition, the extractor main body 31 has the stopper member 347b biased forward by the compression spring 347a, and the stopper member 347b can come in contact with the radially outer portion 346a protruding upward. Therefore, when the filter block 343 extracts coffee in a state where the filter block 343 closes the lower surface opening 341a of the cylinder 341, a downward pressure is generated onto the filter block 343, but the stopper member 347b comes in contact with the radially outer portion 346a, making it possible to suppress descending of the filter block 343.

The extractor 30 constituting the beverage supply apparatus includes: the cylinder 341; the filter block 343 provided to be movable up and down in such a manner as to approach and separate from the cylinder 341; and the paper roller portion 40 that pinches the paper filter 392 pulled out from the filter roll 39 in such a manner as to extend between the cylinder 341 and the filter block 343 and that feeds out the paper filter 392 from the filter roll 39 with forward rotation driving. In this configuration, in a case where the filter block 343 is lowered, the paper roller portion 40 performs forward rotation drive to discharge the extraction residue K generated by extraction and then performs reverse rotation drive to loosen the paper filter 392. Therefore, when the filter block 343 is to be raised at the time of next extraction, it is possible to suppress new feed-out of the paper filter 392 from the filter roll 39, enabling reduction of the use amount of the paper filter 392 accompanying the extraction of the beverage, leading to the reduction of the extraction cost.

Furthermore, by loosening the paper filter 392, it is possible to suppress sticking of the paper filter 392 with the filter block 343 due to drying of the extraction residues K or the like.

Meanwhile, the filter storage portion 38 that rotatably stores the filter roll 39 includes: the encoder 38a that detects the rotation of the filter roll 39; and the distance measuring sensor 38b that detects the distance between the filter storage portion 38 and the filter roll 39, making it possible to detect the remaining amount of the paper filter 392 with high accuracy.

The extractor 30 constituting the beverage supply apparatus feeds the mixing hot water into the cylinder 341 in a state where the mixing hot water is mixed, in the air, with the ground coffee beans at the ingredient chute section 33. This makes it possible to reduce the time required for mixing the ground coffee beans with the mixing hot water, leading to the reduction of the time required for extracting coffee.

In particular, the mixing hot water nozzle 434 configured to eject the mixing hot water ejects the mixing hot water diagonally downward in such a manner as to close a part of the ingredient passage 331 in the ingredient chute section 33, making it possible to reliably mix, in the air, the mixing hot water with ground coffee beans falling through the ingredient passage 331. Moreover, the mixing hot water nozzle 434 causes the mixing hot water to collide with the inner wall surface of the ingredient passage 331, leading to further mixing of the mixing hot water with the ground coffee beans by the collision with the inner wall surface. Since the mixture falls along the inner wall surface to have a further collision against the filter block 343 (paper filter 392) that closes the lower surface opening 341a of the cylinder 341, promoting further mixing. In addition, by falling along the inner wall surface, there is no possibility of contact with the side surface of the cylinder 341.

In the extractor 30, when the exhaust fan 46 is driven, the air in the cylinder 341 is discharged through the exhaust duct 44 communicating with the interior of the cylinder 341 without passing through the ingredient passage 331. This makes it possible to prevent steam from being delivered to the portion of the grinder 32 to which the ground coffee beans are ejected, achieving suppression of sticking of the ground coffee beans.

In addition, since control section 12 controls to reduce the rotation speed of the exhaust fan 46 when ground coffee beans are ejected from the grinder 32, it is possible to prevent fine powder or the like generated with the ejection before grinding coffee from being discharged to the outside through the exhaust duct 44.

Although the preferred embodiments of the present disclosure have been described above, the present disclosure is not limited thereto, and various modifications can be made.

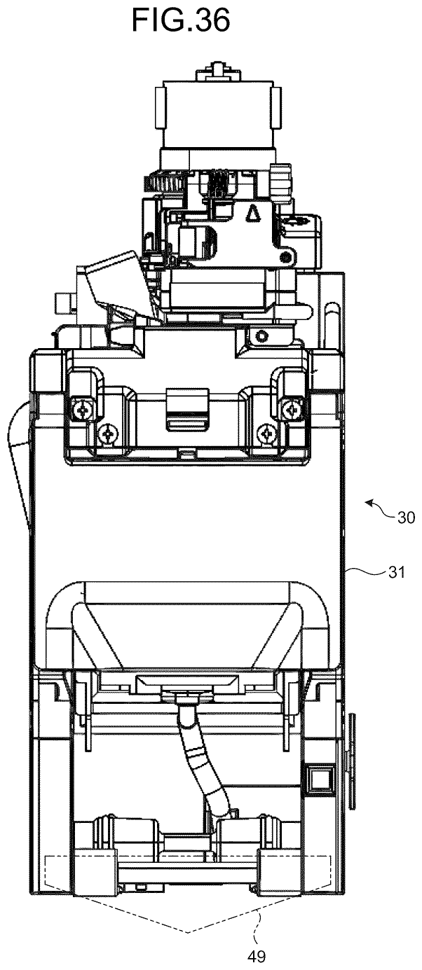

Although not particularly mentioned in the embodiment described above, it is also allowable to detachably provide the extractor main body 31 with a cutter 49 for cutting the paper filter 392 as illustrated in FIG. 36. With the cutter 49 detachably provided in this manner, only the cutter 49 can be removed from the extractor main body 31 for cleaning. Even in this case, extraction of the beverage can be continued as long as the extractor main body 31 is installed, making it possible to prevent loss of opportunities to supply the beverage.

Although not specifically mentioned in the above-described embodiment, a member that detects the conductivity of the passing liquid may be installed on the downstream side of the joint section 63 in the hot water supply path 64. By installing such a member, the concentration and the like of the cleaning liquid can be calculated, enabling correction of the ejection of the cleaning liquid and the like.

In the above-described embodiment, the control section 12 controls the pinch mechanism 36 to bring the passage 351 of the passage constituting member 35 into the closed state when coffee is extracted by the extractor 30. However, in the present disclosure, the following may be performed in some cases.

That is, at an occurrence of pressure abnormality in which the internal pressure becomes excessive due to clogging of ingredients or the like in the coffee extraction path, the control section 12 may control to separate the first pinch component 361 and the second pinch component 362 in the pinch mechanism 36 to bring the passage 351 into an open state.

With this operation, it is possible to prevent the components of the extractor 30 from being damaged or the like. In addition, it is not necessary to provide a relief valve or the like which is required in the related art, making it possible to suppress an increase in manufacturing cost due to an increase in the number of components. Incidentally, in the present disclosure, the internal air may be released by forcibly displacing the filter block 343 downward.

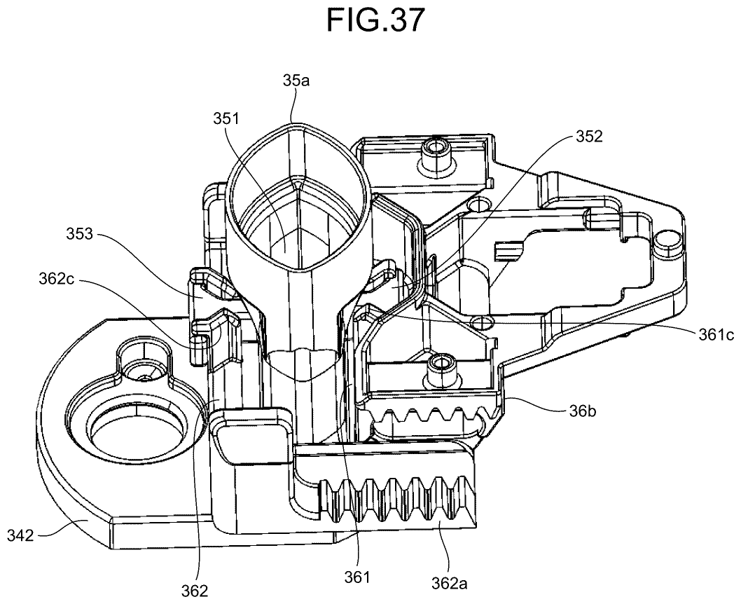

FIG. 37 is a perspective view illustrating a modification of the passage constituting member 35 and the pinch mechanism 36 illustrated in FIG. 11. Note that the same components as those in the above-described configuration are denoted by the same reference numerals, and the description thereof will be appropriately omitted.

As illustrated in FIG. 37, a passage constituting member 35a includes: a first protrusion 352 protruding rearward; and the second protrusion 353 protruding forward. The first protrusion 352 is held by a first holding portion 361c of the first pinch component 361 constituting a pinch mechanism 36b, while the second protrusion 353 is held by a second holding portion 362c of the second pinch component 362 constituting the pinch mechanism 36b.

That is, the pinch mechanism 36b has a configuration in which, on the upper side of the lid member 342, the first pinch component 361 and the second pinch component 362 extending in the left-right direction are disposed to be separated from each other in the front-rear direction, and the passage constituting member 35a is disposed between the first pinch component 361 and the second pinch component 362. In the pinch mechanism 36b, the first holding portion 361c holds the first protrusion 352, while the second holding portion 362c holds the second protrusion 353.

In the pinch mechanism 36b characterized like this, since the first pinch component 361 and the second pinch component 362 are most separated from each other in a normal state, the passage 351 of the passage constituting member 35a is brought into the open state similarly to the state illustrated in part (a) of FIG. 13.

On the other hand, when the first pinch component 361 and the second pinch component 362 are in the highest proximity to each other by the drive of the pinch motor 36a, the pinch mechanism 36b elastically deforms the lower portion of the passage constituting member 35a to bring a part of the passage 351 into the closed state as in the case illustrated in part (b) of FIG. 13.

When the first pinch component 361 and the second pinch component 362 are moved from the state in the proximity to each other to the state of being most separated by the drive of the pinch motor 36a, the first holding portion 361c holds the first protrusion 352 while the second holding portion 362c holds the second protrusion 353, which can forcibly deform the passage constituting member 35a to change the passage 351 from the closed state to the open state.

In this manner, since the passage constituting member 35a can be forcibly deformed to change the state of the passage 351 from the closed state to the open state, it is possible to prevent the wall surfaces of the passage 351 from sticking to each other even when the coffee component or the like adheres to the wall surface of the passage 351.

According to the present disclosure, the extractor includes a passage constituting member, which has a tubular shape and is disposed in a manner so as to allow its interior to communicate with an upper surface opening of the cylinder to constitute a passage of the ingredient and hot water, and the passage constituting member is elastically deformed by an external force to be able to close the passage, leading to suppression of scattering of the ingredients and the like from the cylinder.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A beverage supply apparatus comprising an extractor that feeds a ground ingredient and hot water into a cylinder to extract a beverage, the apparatus configured to supply the beverage extracted by the extractor to a container,
wherein the extractor includes a passage constituting member having a tubular shape and disposed in such a manner as to allow its interior to communicate with an upper surface opening of the cylinder to constitute a passage of the ingredient and the hot water, the passage constituting member configured to be elastically deformed by an external force to be able to close the passage.

2. The beverage supply apparatus according to claim 1, wherein the extractor includes a pinch mechanism, the pinch mechanism having a configuration in which the passage constituting member is disposed between two members facing each other in such a manner as to be separated from each other, the passage is brought into an open state of permitting the ingredient and the hot water to pass through the passage in a normal state, while the passage is brought into a closed state of restricting passing of the ingredient and the hot water through the passage by elastically deforming the passage constituting member when the two members are to be brought into proximity to each other.

3. The beverage supply apparatus according to claim 2, wherein the pinch mechanism forcibly brings the passage constituting member from the closed state into the open state when separating the two members from each other from a state where the two members are brought into proximity to each other.

4. The beverage supply apparatus according to claim 2, further comprising a control section, the control section configured to control the two members constituting the pinch mechanism to be separated from each other to bring the passage constituting member into the open state in a case where a pressure abnormality occurs in an extraction path of the beverage when the beverage is extracted by the extractor.

5. The beverage supply apparatus according to claim 1, wherein the passage constituting member is formed of a resin material.

6. The beverage supply apparatus according to claim 5, wherein the passage constituting member is configured such that at least an inner wall surface of the passage has water repellency.

7. The beverage supply apparatus according to claim 5, wherein the passage constituting member has an elliptical cross section.

8. The beverage supply apparatus according to claim 1, wherein the extractor feeds the hot water into the cylinder in a state where the hot water is mixed in air, as mixing hot water, with the ingredient.

9. The beverage supply apparatus according to claim 8, wherein
the extractor includes an ingredient chute section having an ingredient passage through which the ingredient is dropped toward the cylinder, and
the ingredient chute section includes a mixing hot water nozzle that ejects the mixing hot water to a part of the ingredient passage.

10. The beverage supply apparatus according to claim 9, wherein the mixing hot water nozzle ejects the mixing hot water diagonally downward in such a manner as to close the part of the ingredient passage.

11. The beverage supply apparatus according to claim 10, wherein the mixing hot water nozzle ejects the mixing hot water in a fan shape.

12. The beverage supply apparatus according to claim 10, wherein the mixing hot water nozzle causes the mixing hot water to collide with an inner wall surface of the ingredient passage.

13. The beverage supply apparatus according to claim 9, wherein the extractor includes:
an intake port formed in a region above a portion to which the ingredient is ejected and configured to suck air; and
an exhaust means configured to discharge, when driven, air in the cylinder through an exhaust duct communicating with an interior of the cylinder without passing through the ingredient passage.

14. The beverage supply apparatus according to claim 13, wherein the exhaust means reduces its rotation speed at the time of ejecting the ingredient.
